(19) United States
(12) Patent Application Publication
(10) Pub. No.: US 2025/0174719 A1
(43) Pub. Date: May 29, 2025

(54) ELECTROLYTE FOR LITHIUM SECONDARY BATTERY, AND LITHIUM SECONDARY BATTERY INCLUDING THE SAME

(71) Applicant: Samsung SDI Co., Ltd., Yongin-si (KR)

(72) Inventors: Soojin Kim, Yongin-si (KR); Dongyoung Kim, Yongin-si (KR); Seulwoo Kim, Yongin-si (KR); Donghee Yeon, Yongin-si (KR); Jongseok Park, Yongin-si (KR)

(21) Appl. No.: 18/643,427

(22) Filed: Apr. 23, 2024

(30) Foreign Application Priority Data
Nov. 28, 2023 (KR) 10-2023-0168454

(51) Int. Cl. H01M 10/0567; H01M 4/02; H01M 4/133; H01M 4/583; H01M 4/66; H01M 10/052; H01M 10/0568; H01M 50/414

(52) U.S. Cl. CPC H01M 10/0567; H01M 4/133; H01M 4/583; H01M 4/661; H01M 10/052; H01M 10/0568; H01M 50/414; H01M 2004/027

(57) ABSTRACT

An electrolyte for a lithium secondary battery including an additive represented by Formula 1, and a lithium secondary battery including a negative electrode, a positive electrode, and the electrolyte between the positive electrode and the negative electrode are provided.

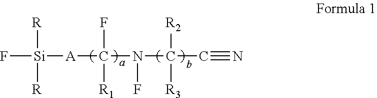

In Formula 1, A represents a chemical bond or —(CH₂)ₖ— (wherein k is an integer from 1 to 3), a and b are each independently 0 or an integer from 1 to 3, and a and b are not both integers from 1 to 3 simultaneously, and R, R₁, R₂, and R₃ are each independently hydrogen, a C1-C10 alkyl group, or F.

### CROSS-REFERENCE TO RELATED APPLICATION

The present application claims priority to and the benefit of Korean Patent Application No. 10-2023-0168454, filed on Nov. 28, 2023, in the Korean Intellectual Property Office, the entire content of which is incorporated herein by reference.

### BACKGROUND

### 1. Field

One or more embodiments of the present disclosure relate to an electrolyte for a lithium secondary battery, and a lithium secondary battery including the electrolyte.

### 2. Description of the Related Art

Lithium secondary batteries are rechargeable and have three times or more higher energy density per unit weight than that of comparable lead-acid batteries, nickel-cadmium batteries, nickel-hydrogen batteries, or nickel-zinc batteries and may be charged at relatively high speed(s). Thus, lithium secondary batteries have been commercialized for utilization in laptop computers, smart phones, electric tools, E-bikes, electric vehicles, and/or the like, and research has been conducted to further increase energy density.

With the development of high performance information technology (IT) devices, it is desirable to develop relatively high-capacity batteries. Although energy density of a battery may be increased by realizing high capacity through expanding a voltage range, an electrolytic solution may be oxidized in a high voltage range, deteriorating performance of a positive electrode of the battery.

For example, LiPF₆, which is the most commonly utilized as a lithium salt of electrolytic solutions, reacts with a solvent of the electrolytic solution to promote depletion of the solvent and generate a large amount of gas. While LiPF₆ is degraded, degradation products such as HF and PF₅ are produced, causing depletion of the electrolytic solution in a battery and deterioration of performance at a high temperature and safety of the battery.

Degradation products of the electrolytic solution may be deposited on the surface of an electrode in the form of a film to increase internal resistance of a battery, resulting in performance deterioration and a decrease in a lifespan of the battery. Such side reactions are accelerated at a high temperature where reaction rates increase, and gaseous components, produced as a result of the side reactions, increase internal pressure of the battery to deteriorate stability of the battery.

### SUMMARY

One or more aspects of embodiments of the present disclosure are directed toward an electrolyte for a lithium secondary battery that is stable even under relatively high-voltage and/or relatively high-temperature conditions with relatively high-capacity positive electrodes by inhibiting degradation of an electrolytic solution and reducing side reactions caused by oxidation of the electrolytic solution occurring on the surface of a positive electrode of the lithium secondary battery.

One or more aspects of embodiments of the present disclosure are directed toward a lithium secondary battery including the electrolyte for a lithium secondary battery.

Additional aspects will be set forth in part in the description which follows and, in part, will be apparent from the description, or may be learned by practice of the presented embodiments of the present disclosure.

According to one or more embodiments of the present disclosure, a lithium secondary battery includes a positive electrode, a negative current collector, and an electrolyte between the positive electrode and the negative current collector,
wherein the electrolyte includes an additive represented by Formula 1.

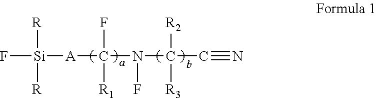

In Formula 1, A may represent a chemical bond or —(CH₂)ₖ— (wherein k may be an integer from 1 to 3),
a and b may each independently be 0 or an integer from 1 to 3,
a and b may not be both integers from 1 to 3 simultaneously (e.g., at least one of a or b is (e.g., has to be) 0), and
R, R₁, R₂, and R₃ may each independently be hydrogen, a C1-C10 alkyl group, or F.

According to one or more embodiments of the present disclosure, an electrolyte for a lithium secondary battery includes an additive represented by Formula 1.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the present disclosure will be more apparent from the following description taken in conjunction with the accompanying drawings, in which:

FIGS. 1-4 are each of a cross-sectional view schematically illustrating a lithium secondary battery according to one or more embodiments of the present disclosure;

FIG. 5A is a schematic view of a stack structure of a lithium secondary battery according to one or more embodiments of the present disclosure; and

FIG. 5B is a schematic view of a stack structure of a lithium secondary battery according to one or more embodiments of the present disclosure.

### DETAILED DESCRIPTION

Reference will now be made in more detail to embodiments, examples of which are illustrated in the accompanying drawings, wherein like reference numerals refer to like elements throughout the present disclosure, and duplicative descriptions thereof may not be provided for conciseness. In this regard, the embodiments of the present disclosure may have different forms and should not be construed as being limited to the descriptions set forth herein. For example, the embodiments of the present disclosure are merely described, by referring to the drawings, to explain aspects of the present disclosure. As utilized herein, the term “and/or” or “or” may include any and all combinations of one or more of the associated listed items. Expressions such as “at least one of,” “one of,” and “at least one selected from,” if (e.g., when) preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof.

The presented embodiments of the present disclosure described herein allows one or more suitable changes and numerous embodiments, particular embodiments will be illustrated in the drawings and described in more detail in the written description. However, this is not intended to limit the present disclosure to particular modes of practice, and it is to be appreciated that all modifications, equivalents, and substitutes that do not depart from the spirit and technical scope of the present disclosure are encompassed in the present disclosure.

The terms utilized herein are merely utilized to describe example embodiments and are not intended to limit the present disclosure. An expression utilized in the singular encompasses the expression of the plural, unless it has a clearly different meaning in the context. For example, the singular forms “a,” “an,” and “the” are intended to include the plural forms as well, unless the context clearly indicates otherwise. In the present disclosure, it is to be understood that the terms such as “include(s)/including,” “comprise(s)/comprising,” or “have(has)/having” etc., are intended to indicate the existence of the features, numbers, operations, elements, parts, components, materials, or combinations thereof disclosed in the disclosure, and are not intended to preclude the possibility that one or more other features, numbers, operations, elements, parts, components, materials, or combinations thereof may exist or may be added. As utilized herein, the “/” may be interpreted as either “and” or “or” depending on situations.

In the drawings, thicknesses of one or more suitable layers and regions may be enlarged or reduced for clarity. Throughout the disclosure, like reference numerals denote like elements. Throughout the disclosure, it will be understood that when one element such as layer, film, region, or plate, is referred to as being “on” another element, it may be directly on the other element, or intervening elements may also be present therebetween. In contrast, when an element is referred to as being “directly on” another element, there are no intervening elements present. Although the terms “first,” “second,” etc. may be utilized herein to describe one or more suitable components, these components should not be limited by these terms. These terms are only utilized to distinguish one component from another. In the disclosure and drawings, components having substantially the same functional configuration are referred to by the same reference numerals, and redundant descriptions are not provided for conciseness.

In the present disclosure, a “particle diameter” or “particle size” of particles indicates an average diameter of spherical particles or an average length of major axes of non-spherical particles. Particle diameters of particles may be measured utilizing a particle size analyzer (PSA), for example, HORIBA, LA-950 laser particle size analyzer. The “particle diameter” of particles is, for example, an average particle diameter. The average particle diameter is, for example, a median particle diameter (D50). The median particle diameter D50 may be a particle diameter corresponding to a 50% cumulative volume calculated from the smallest particle to the largest particle in a particle size distribution measured, for example, by laser diffraction method. In one or more embodiments, the average diameters and average lengths of major axes of particles may be measured by utilizing a scanning electron microscope (SEM). If (e.g., when) measured by utilizing an SEM, an average value of more than 30 randomly selected particles having a diameter of 1 micrometer (μm) or more, excluding fine particles, is utilized.

In the present disclosure, the term “metal” includes metals and metalloids such as silicon and germanium in an elemental or ionic state.

In the present disclosure, the term “alloy” refers to a combination of two or more metals.

In the present disclosure, the term “positive active material” refers to a material for positive electrodes allowing lithiation and delithiation, and the term “negative active material” refers to a material for negative electrodes allowing lithiation and delithiation.

In the present disclosure, the terms “lithiation” and “lithiating” refer to a process of adding lithium to a positive active material or a negative active material, and the terms “delithiation” and “delithiating” refer to a process of removing lithium from a positive active material or a negative active material.

In the present disclosure, the terms “charging” and “charge” refer to a process of supplying electrochemical energy to a battery. In the present disclosure, the terms “discharging” and “discharge” refer to a process of removing electrochemical energy from a battery.

In the present disclosure, the terms “positive electrode” and “cathode” refer to an electrode in which electrochemical reduction and lithiation occur during discharging. In the present disclosure, the terms “negative electrode” and “anode” refer to an electrode in which electrochemical oxidation and delithiation occur during discharging.

The term “thickness” as utilized herein refers to, for example, an average thickness. The “thickness” measured utilizing software from a scanning electron microscope image.

Hereinafter, an electrolyte for a lithium secondary battery and a lithium secondary battery including the electrolyte according to one or more embodiments will be described in more detail.

In general, if (e.g., when) an electrolytic solution containing LiPF₆ as a lithium salt is exposed to high temperature, LiPF₆ may be degraded into LiF and PF₅ in an electrolyte containing a small amount of water, and HF generated therefrom reacts with an organic solvent to produce gas and reacts with a positive electrode to elute metal ions. As a result, high-temperature stability and lifespan characteristics of a lithium secondary battery may deteriorate.

For example, oxidation of the electrolytic solution may be accelerated in a high voltage range, resulting in a significant increase in resistance of an electrode during a long-term charging and discharging process. Therefore, it is desirable to develop an electrolytic solution applicable under high-voltage and high-temperature conditions. For example, it is desirable to develop an electrolytic solution having excellent or suitable ionic conductivity and stability.

For example, the electrolyte may be required and desirable to have high stability to the extent that side reactions do not occur even at a high voltage of 4.5 V or more under high-temperature conditions.

To obtain an electrolyte having excellent or suitable high-voltage characteristics, utilization of a nitrile-based compound as an additive of an electrolyte has been suggested. However, oxidation potential characteristics of the nitrile-based compound so far are not satisfactory, and thus improvements in this regard are desired.

One or more embodiments of the present disclosure provide an electrolyte for a lithium secondary battery including an additive of Formula 1 that is a nitrile-based compound. If (e.g., when) the electrolyte of the present disclosure is applied to a high-voltage positive electrode, oxidation resistance may increase due to high oxidation potential, which improves lifespan characteristics of the electrolyte, and HF that is a cause of deterioration at a high temperature may be removed. Therefore, by utilizing such an electrolyte, a lithium secondary battery with improved characteristics at a high temperature may be provided.

The electrolyte for a lithium secondary battery according to one or more embodiments may include an additive represented by Formula 1.

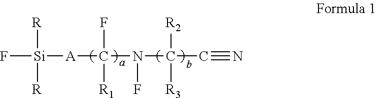

In Formula 1, A may represent a chemical bond or —(CH₂)ₖ— (wherein k is an integer from 1 to 3),
a and b may each independently be 0 or an integer of 1 to 3,
a and b may not be both integers from 1 to 3 simultaneously (e.g., at least one of a or b may be (e.g., has to be) 0), and
R, R₁, R₂, and R₃ may each independently be hydrogen, a C1-C10 alkyl group, or F.
k may be an integer of 1, 2, or 3.

A lithium secondary battery according to one or more embodiments may include a positive electrode, a negative current collector, and an electrolyte between the positive electrode and the negative current collector, wherein the electrolyte may include the additive represented by Formula 1.

The C1-C10 alkyl group may be, for example, a methyl group, an ethyl group, a propyl group, a butyl group, a pentyl group, or a hexyl group.

The additive may be an organic material enabling electrical behavior in a high-temperature, high-voltage environment, and such an organic material has high oxidation resistance. As shown in Formula 1, if (e.g., when) an N—F functional group and a nitrile (—C≡N) terminal group are applied, not only the oxidation potential increases, but also HF, which is a degradation product of LiPF₆ utilized as a lithium salt at a high temperature, may be removed. HF, which is the most important material inducing a side reaction that induces elution of a transition metal of a positive electrode at a high temperature, may cause deterioration of the positive electrode and increases resistance. HF may be removed by utilizing the electrolyte according to one or more embodiments as described herein, and thus a lithium secondary battery having improved high-temperature and high-voltage characteristics may be provided.

In one or more embodiments, the additive represented by Formula 1 may include, for example, at least one selected from the compounds represented by Formulae 2 to 8.

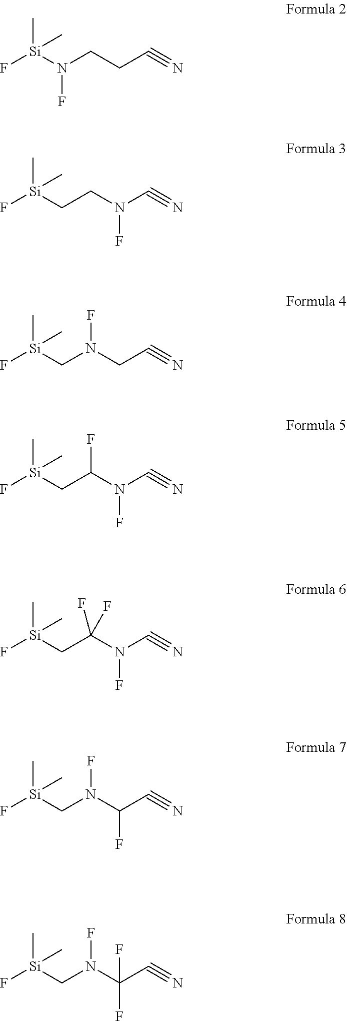

In one or more embodiments, a content (e.g., amount) of the additive represented by Formula 1 may be from about 0.1 wt % to about 10 wt %, from about 0.1 wt % to about 8 wt %, from about 0.1 wt % to about 6 wt %, from about 0.1 wt % to about 5 wt %, from about 1 wt % to about 5 wt %, or from about 1 wt % to about 3 wt %, based on a total weight of the electrolyte. If (e.g., when) the content (e.g., amount) of the additive of Formula 1 is within the ranges described above, a lithium secondary battery having improved high-voltage characteristics, high-temperature storage characteristics, and lifespan characteristics may be prepared.

The additive of Formula 1 is a material having very strong lithium cation interaction and anion interaction. By utilizing the additive, anions may also be induced to migrate while initially charging lithium ions migrate from the positive electrode to the negative electrode. As a result, more anions are induced to be present in the negative electrode enriching a clustered solvation structure, and thus a strong film including abundant boron and fluorine ions, as anions, may be formed.

The lithium secondary battery may include lithium ion batteries, lithium metal batteries, solid secondary batteries, and/or the like.

### Electrolyte

The electrolyte for a lithium secondary battery may include a non-aqueous organic solvent and a lithium salt, in addition to the additive of the present disclosure.

The non-aqueous organic solvent may serve as a medium through which ions involved in electrochemical reaction of the battery may migrate.

The lithium salt may be a material dissolved in the non-aqueous organic solvent to serve as a source of lithium ions in the battery enabling a basic operation of the lithium secondary battery and promoting migration of lithium ions between the positive electrode and the negative electrode. Representative examples of the lithium salt may include one or more selected from LiPF₆, LiBF₄, LiSbF₆, LiAsF₆, LiClO₄, LiAlO₂, LiAlCl₄, LiPO₂F₂, LiCl, LiI, LiN(SO₂C₂F₅)₂, lithium bis(fluorosulfonyl)imide (Li(FSO₂)₂N, LiTFSI), LiC₄F₉SO₃, LiN(CₓF₂ₓ₊₁SO₂)(C_{y}F_{2y+1}SO₂) (wherein x and y are each independently an integer from 1 to 20), lithium trifluoromethane sulfonate (LiSO₃CF₃), lithium pentafluoroethanesulfonate (LiSO₃C₂F₅), lithium tetrafluoroethanesulfonate (LiSO₃C₂F₄), lithium difluorobis(oxalato)phosphate (LiDFOB), and lithium bis(oxalato)borate (LiBOB).

According to some embodiments, the lithium salt may include a first lithium salt and a second lithium salt. The electrolyte may have improved ionic conductivity by including the first lithium salt and the second lithium salt.

The first lithium salt and the second lithium salt may each be a borate-based lithium salt. The borate-based lithium salt has superior high-temperature stability to that of phosphorous-based lithium salts and may inhibit generation of hydrofluoric acid (HF). If (e.g., when) the first lithium salt and the second lithium salt includes a borate-based lithium salt, high-temperature cycle characteristics of the lithium secondary battery may be improved.

In one or more embodiments, the first lithium salt and the second lithium salt may be, for example, each independently a fluorine-containing borate-based lithium salt. A composition of an SEI (solid electrolyte interphase) layer formed during charging and discharging of the lithium secondary battery may be modified more effectively because the first lithium salt and the second lithium salt include the fluorine-containing borate-based lithium salt. For example, as a content (e.g., amount) of fluorine (F) of the SEI layer increases, structural stability of the SEI layer may be improved, and side reactions with the non-aqueous organic solvent may be effectively inhibited. As a result, reversibility of electrode reaction of the lithium secondary battery may be improved.

The first lithium salt and the second lithium salt may be, for example, each independently a non-cyclic borate lithium salt and/or a cyclic borate lithium salt. If (e.g., when) the first lithium salt is a non-cyclic borate lithium salt, ionic conductivity of the electrolyte may be improved more effectively. If (e.g., when) the second lithium salt is a cyclic borate lithium salt, aggregation of anions may increase, and thus the composition of the SEI layer may be modified more effectively and high-temperature stability of the electrolyte may be enhanced.

The fluorine-containing borate-based lithium salt may include, for example, LiBF₄, LiBF₃(C₂F₅), a compound represented by one selected from among Formulae 1-1 to 1-12, or any combination thereof.

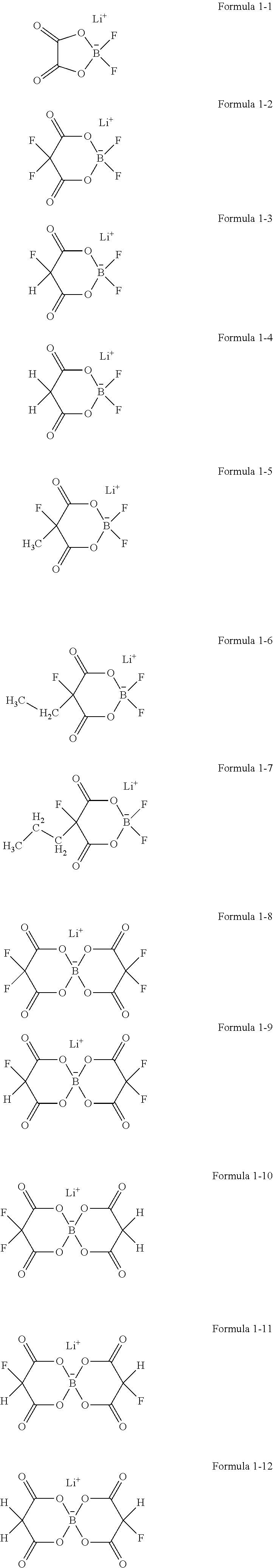

In one or more embodiments, the first lithium salt may include, for example, LiBF₄, and the second lithium salt may include one or more compounds selected from the compounds represented by Formulae 1-1 to 1-12.

In one or more embodiments, the first lithium salt may include LiBF₄, and the second lithium salt may include, for example, lithium difluoro(oxalato)borate (LiDFOB) of Formula 1-1.

In one or more embodiments, a content (e.g., amount) ratio of the first lithium salt to the second lithium salt may be, for example, from about 1:9 to about 9:1, from about 3:7 to about 7:3, or from about 4:6 to about 6:4. If (e.g., when) the content (e.g., amount) ratio of the first lithium salt to the second lithium salt is within the ranges described above, the electrolyte may provide formation of an SEI layer having both (e.g., simultaneously) excellent or suitable ionic conductivity and structural stability. The content (e.g., amount) ratio of the first lithium salt to the second lithium salt may be, for example, a molar ratio.

According to one or more embodiments, a mixing weight ratio of lithium difluoro(oxalato)borate (LiDFOB) to lithium tetrafluoroborate (LiBF₄) may be from about 1:2 to about 1:0.3 or from about 1:1.5 to about 1:0.5. If (e.g., when) the concentration of the lithium salt and the mixing weight ratio of LiDFOB to LiBF₄ are within the ranges described above, a lithium secondary battery having improved performance may be manufactured. If (e.g., when) the content (e.g., amount) of LiBF₄ is more than the ranges described above, better interaction of the nitrile-based compound with LiDFOB may be confirmed, but the possibility of meeting LiDFOB may significantly decrease to be unfavorable for formation of a film. If (e.g., when) the content (e.g., amount) of LiDFOB is more than the ranges described above, viscosity of the electrolyte may increase, and thus ion mobility may decrease, resulting in a decrease in initial capacity of the lithium secondary battery.

In one or more embodiments, a concentration of the lithium salt (e.g., including both the first lithium salt and the second lithium salt) in the electrolyte may be, for example, from about 0.01 M to about 5.0 M, from about 0.05 M to about 5.0 M, from about 0.1 M to about 5.0 M, from about 0.1 M to about 3 M, from about 0.1 M to about 2.4 M, from about 0.3 M to about 1.5 M, from about 0.5 M to about 1.2 M, or from about 0.8 M to about 1.2 M. If (e.g., when) the concentration of the lithium salt is within the ranges described above, the lithium secondary battery may have further improved characteristics.

The non-aqueous organic solvent may include at least one selected from among a carbonate-based solvent, an ester-based solvent, an ether-based solvent, a nitrile-based solvent, an alcohol-based solvent, and a ketone-based solvent.

As the carbonate-based solvent, ethyl methyl carbonate (EMC), methyl propyl carbonate (MPC), ethyl propyl carbonate (EPC), dimethyl carbonate (DMC), diethyl carbonate (DEC), dipropyl carbonate (DPC), propylene carbonate (PC), ethylene carbonate (EC), butylene carbonate (BC), and/or the like may be utilized.

As the ester-based solvent, methyl propionate, ethyl propionate, ethyl butyrate, methyl acetate, ethyl acetate, n-propyl acetate, dimethyl acetate, γ-butyrolactone, decanolide, γ-valerolactone, mevalonolactone, caprolactone, and/or the like may be utilized. As the ether-based solvent, dibutyl ether, tetraglyme, diglyme, dimethoxyethane, 2-methyltetrahydrofuran, tetrahydrofuran, and/or the like may be utilized. As the ketone-based solvent, cyclohexanone and/or the like may be utilized. As the nitrile-based solvent, acetonitrile (AN), succinonitrile (SN), adiponitrile, butyronitrile, and/or the like may be utilized.

As the ether-based solvent, dibutyl ether, tetraglyme, diglyme, dimethoxyethane, 2-methyltetrahydrofuran, 2,5-dimethyltetrahydrofuran, tetrahydrofuran, and/or dioxolane such as 1,3-dioxolane and 1,4-dioxolane may be utilized. For example, as the ketone-based solvent, cyclohexanone, and/or the like may be utilized. As the alcohol-based solvent, ethyl alcohol, isopropyl alcohol, and/or the like may be utilized. Other solvents available therefor may be nitriles such as R—CN (wherein R may be a linear, branched, or cyclic C2-C20 hydrocarbon group and may include a double bond, an aromatic ring, or an ether group); in some embodiments, amides such as dimethylformamide, sulfolanes such as ethylmethoxyethyl sulfolane and ethylmethyl sulfolane, and phosphates such as trimethyl phosphate may be utilized.

The non-aqueous organic solvent may be utilized alone or in a combination of at least two thereof.

For example, if (e.g., when) the carbonate-based solvent is utilized, a mixture of a cyclic carbonate and a chain carbonate may be utilized, and the cyclic carbonate may be mixed with the chain carbonate in a volume ratio of about 1:1 to about 1:9.

Other solvents contained in the electrolyte may be dimethyl sulfoxide, dimethylformamide, dimethylacetamide, tetrahydrofuran, and/or the like, but embodiments of the present disclosure are not limited thereto, and any suitable organic solvents in the art may also be utilized. For example, in some embodiments, the non-aqueous organic solvent may include a mixed solvent of about 50 vol % to about 95 vol % of a chain carbonate and 5 vol % to about 50 vol % of a cyclic carbonate, for example, a mixed solvent of about 70 vol % to about 95 vol % of the chain carbonate and about 5 vol % to about 30 vol % of the cyclic carbonate. For example, in some embodiments, the non-aqueous organic solvent may be a mixed solvent of three or more organic solvents.

According to one or more embodiments, the electrolyte may include a nitrile-based compound, a lithium salt, and a carbonate-based compound, and the lithium salt may include lithium difluoro(oxalato)borate (LiDFOB) and lithium tetrafluoroborate (LiBF₄).

The nitrile-based compound may be, for example, butyronitrile, valeronitrile, propionitrile, acetonitrile, or one or more combinations thereof. In the lithium secondary battery, a content (e.g., amount) of the nitrile-based compound may be from about 3 wt % to about 45 wt % based on 100 wt % of a total weight of the electrolyte.

In one or more embodiments, a lithium metal layer may be included between the negative current collector and the electrolyte.

The electrolyte for a lithium secondary battery according to one or more embodiments may have an oxidation potential of about 4.50 V to about 5.40 V or about 4.52 V to about 5.32 V. As utilized herein, the term “oxidation potential” refers to a potential at which oxidation is initiated, i.e., a degradation start voltage. The oxidation potential may vary according to types (kinds) of the non-aqueous organic solvent of the electrolyte utilized with the additive. In the present disclosure, the oxidation potential refers to a value measured by utilizing a carbonate-based solvent as the non-aqueous organic solvent of the electrolyte. In some embodiments, although a different solvent is utilized in an actual electrolyte, the above-described value may be satisfied if (e.g., when) the oxidation potential is measured by utilizing the additive of the electrolyte according to one or more embodiments and the non-aqueous organic solvent. The degradation start voltage may refer to a potential at which a change of 0.00001 A/cm² starts to be seen in a current, and the measurement is conducted at room temperature of about 20° C. to about 25° C. under atmospheric conditions. An amount of the additive of Formula 1 may be about 0.1 wt % to about 10 wt % based on the total weight of the electrolyte. If (e.g., when) the additive is added in an amount of about 0.1 wt % to about 1 wt % based on the total weight of the electrolyte, a peak intensity of current change may be easily identified by visual observation.

The additive may be involved in reaction in the early stage of overcharging to obtain safety, because the electrolyte according to one or more embodiments includes the additive having the above-described oxidation potential. In this manner, recoverability during storage and safety in the event of overcharging, which are difficult to obtain with additive alone, may be realized.

After storing the lithium secondary battery including the electrolyte at a high temperature (60° C.), a concentration (ppm) of HF may be 20 ppm or less, 15 ppm or less, 13 ppm or less, or 12 ppm or less. After storing the lithium secondary battery including the electrolyte according to one or more embodiments at a high temperature (60° C.), the concentration (ppm) of HF may be evaluated according to a method described in Evaluation Example 2.

The electrolyte according to one or more embodiments may be in a liquid or gel state. For example, in some embodiments, the electrolyte may be prepared by adding a lithium salt and the above-described additive to a non-aqueous organic solvent.

A lithium secondary battery according to one or more embodiments may include: a positive electrode including a positive active material; a negative current collector; and the above-described electrolyte between the positive electrode and the negative current collector.

A lithium secondary battery according to one or more embodiments may include the electrolyte according to one or more embodiments, a positive electrode, and a negative electrode.

### Positive Electrode

A lithium secondary battery according to one or more embodiments may include a positive electrode, and the positive electrode may include a positive current collector and a positive active material layer on a side (e.g., one side) of the positive current collector and including a positive active material. In one or more embodiments, the lithium secondary battery may be, for example, a lithium metal battery.

### Positive Electrode: Positive Active Material Layer

As the positive active material, a compound allowing reversible intercalation and deintercalation of lithium (lithiated intercalation compound) may be utilized. For example, one or more types (kinds) of composite oxides of lithium and a metal selected from cobalt, manganese, nickel, and any combination thereof may be utilized.

The composite oxide may be a lithium transition metal composite oxide, and non-limiting examples thereof may be a lithium nickel oxide, a lithium cobalt oxide, a lithium manganese oxide, a lithium iron phosphate compound, a cobalt-free nickel-manganese oxide, or one or more combinations thereof.

Non-limiting examples of the composite oxides may include one or more of compounds represented by the following formulae: LiₐA_{1-b}X_{b}O_{2-c}D_{c} (wherein 0.90≤a≤1.8, 0≤b≤0.5, and 0≤c≤0.05); LiₐMn_{2-b}X_{b}O_{4-c}D_{c} (wherein 0.90≤a≤1.8, 0≤b≤0.5, and 0≤c≤0.05); LiₐNi_{1-b-c}Co_{b}X_{c}O_{2-α}D_{α} (wherein 0.90≤a≤1.8, 0≤b≤0.5, 0≤c≤0.5, and 0<α<2); LiₐNi_{1-b-c}Mn_{b}X_{c}O_{2-α}D_{α} (wherein 0.90≤a≤1.8, 0≤b≤0.5, 0≤c≤0.5, and 0<α<2); LiₐNi_{b}Co_{c}L¹_{d}GₑO₂ (wherein 0.90≤a≤1.8, 0≤b≤0.9, 0≤c≤0.5, 0≤d≤0.5, and 0≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMn_{1-b}G_{b}O₂ (wherein 0.90≤a≤1.8 and 0.001≤b≤0.1); LiₐMn₂G_{b}O₄ (wherein 0.90≤a≤1.8 and 0.001≤b≤0.1); LiₐMn_{1-g}G_{g}PO₄ (wherein 0.90≤a≤1.8 and 0≤g≤0.5); Li_{(3-f)}Fe₂(PO₄)₃ (wherein 0≤f≤2); and LiₐFePO₄ (wherein 0.90≤a≤1.8).

In the formulae, A may be nickel (Ni), cobalt (Co), manganese (Mn), or any combination thereof; X may be aluminum (Al), Ni, Co, Mn, chromium (Cr), iron (Fe), magnesium (Mg), strontium (Sr), vanadium (V), a rare earth element, or any combination thereof; D may be oxygen (O), fluorine (F), sulfur (S), phosphorus (P), or any combination thereof; G may be Al, Cr, Mn, Fe, Mg, lanthanum (La), cerium (Ce), Sr, V, or any combination thereof; and L¹ may be Mn, Al, or any combination thereof.

In one or more embodiments, the positive active material may include, for example, a lithium transition metal oxide represented by one selected from among Formulae 25 to 32.

LiₐNiₓCO_{y}M_{z}O_{2-b}A_{b} Formula 25

In Formula 25, 1.0≤a≤1.2, 0≤b≤0.2, 0.8≤x<1, 0≤y≤0.3, 0<z≤0.3, and x+y+z=1,

M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and

A may be F, S, Cl, Br, or any combination thereof.

LiNiₓCo_{y}Mn_{z}O₂ Formula 26

LiNiₓCo_{y}Al_{z}O₂ Formula 27

In Formulae 26 and 27, 0.8≤x≤0.95, 0≤y≤0.2, 0≤z≤0.2, and x+y+z=1.

LiNiₓCo_{y}Mn_{z}Al_{w}O₂ Formula 28

In Formula 28, 0.8≤x≤0.95, 0≤y≤0.2, 0<z≤0.2, 0<w≤0.2, and x+y+z+w=1.

LiₐCoₓM_{y}O_{2-b}A_{b} Formula 29

In Formula 29, 1.0≤a≤1.2, 0≤b≤0.2, 0.9≤x≤1, 0≤y≤0.1, and x+y=1,

M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A may be F, S, Cl, Br, or any combination thereof.

LiₐNiₓMn_{y}M′_{z}O_{2-b}A_{b} Formula 30

In Formula 30, 1.0≤a≤1.2, 0≤b≤0.2, 0<x≤0.3, 0.5≤y<1, 0<z≤0.3, and x+y+z=1, M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A may be F, S, Cl, Br, or any combination thereof.

LiₐM1ₓM2_{y}PO_{4-b}X_{b} Formula 31

In Formula 31, 0.90≤a≤1.1, 0≤x≤0.9, 0≤y≤0.5, 0.9<x+y<1.1, and 0≤b≤2,

M1 may be chromium (Cr), manganese (Mn), iron (Fe), cobalt (Co), nickel (Ni), copper (Cu), zirconium (Zr), or any combination thereof, and

M2 may be magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or any combination thereof, and X may be O, F, S, P, or any combination thereof.

LiₐM3_{z}PO₄ Formula 32

In Formula 32, 0.90≤a≤1.1, 0.9≤z≤1.1, and M3 may be chromium (Cr), manganese (Mn), iron (Fe), cobalt (Co), nickel (Ni), copper (Cu), zirconium (Zr), or any combination thereof.

In one or more embodiments, the positive active material layer may further include a conductive material. The conductive material may be one or more of carbon black, graphite particulates, natural graphite, artificial graphite, acetylene black, Ketjen black, carbon fiber; carbon nanotubes; metals such as copper, nickel, aluminum, and silver each of which is utilized in powder, fiber, or tube form; or conductive polymers such as polyphenylene derivatives, but embodiments of the present disclosure are not limited thereto, and any material utilized in the art as conductive materials may also be utilized. In some embodiments, the positive electrode may not include (e.g., may exclude) a separate conductive material.

In one or more embodiments, the positive active material layer may further include, for example, a binder. The binder may be, for example, a vinylidene fluoride/hexafluoropropylene copolymer, polyvinylidene fluoride, polyacrylonitrile, polymethylmethacrylate, polytetrafluoroethylene (PTFE), any mixture thereof, or a styrene butadiene rubber polymer.

In one or more embodiments, a content (e.g., amount) of the positive active material included in the positive active material layer may be, for example, from about 80 wt % to about 99 wt %, from about 90 wt % to about 99 wt %, or from about 95 wt % to about 99 wt %, based on a total weight of the positive active material layer.

In one or more embodiments, a content (e.g., amount) of the conductive material included in the positive active material layer may be, for example, from about 0.1 wt % to about 10 wt %, or from about 0.1 wt % to about 5 wt %, based on a total weight of the positive active material layer.

In one or more embodiments, a content (e.g., amount) of the binder included in the positive active material layer may be, for example, from about 0.1 wt % to about 10 wt %, or from about 0.1 wt % to about 5 wt %, based on a total weight of the positive active material layer.

Contents of the positive active material, the conductive material, and the binder may be the same levels as those utilized in lithium batteries. In some embodiments, at least one of the conductive material or the binder may not be provided in accordance with a utilization and/or a configuration of the lithium battery.

For example, in one or more embodiments, the positive active material may be a high nickel-based positive active material having a nickel content (e.g., amount) of 80 mol % or more, 85 mol % or more, 90 mol % or more, 91 mol % or more, or 94 mol % or more, but not more than 99 mol %, based on 100 mol % of metals other than lithium in the lithium transition metal composite oxide. The high nickel-based positive active material capable of realizing high capacity may be applied to high-capacity, high-density lithium secondary batteries.

### Positive Electrode: Positive Current Collector

A material constituting the positive current collector may be any material that does not react with lithium, i.e., any conductive material that does not form an alloy or a compound with lithium. The positive current collector may be formed of, for example, a metal or an alloy. In one or more embodiments, the positive current collector may be formed of, for example, aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. For example, the positive current collector may be in a form selected from foil, film, plate, porous structure, mesoporous structure, through-hole-containing structure, polygonal ring, mesh, foam, and non-woven structure, but is not limited thereto, and may be in any form commonly available in the art.

In some embodiments, the positive current collector may include, for example, a base film and a metal layer on one side or both (e.g., two opposite) sides of the base film. The base film may include, for example, a polymer. The polymer may be, for example, a thermoplastic polymer. The polymer may include, for example, polyethyleneterephthalate (PET), polyethylene (PE), polypropylene (PP), polybutyleneterephthalate (PBT), polyimide (PI), or any combination thereof. The polymer may be an insulating polymer. If (e.g., when) the base film includes an insulating thermoplastic polymer, the base film may soften or liquefy in the event of a short circuit to stop the operation of a battery, thereby inhibiting a rapid increase in current. The metal layer may include, for example, aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. In some embodiments, the positive current collector may further include a metal chip and/or a lead tab. For detailed descriptions of the base film, the metal layer, the metal chip, and the lead tab of the positive current collector, reference may refer to the negative positive current collector which will be described elsewhere herein. If (e.g., when) the positive current collector has the above-described structure, the weight of the positive electrode may be reduced, so that energy density of the positive electrode and the lithium battery may be increased.

In one or more embodiments, the positive electrode for a lithium secondary battery may include a positive current collector and a positive active material layer formed on the positive current collector. The positive active material layer may include a positive active material and may further include a binder and/or a conductive material.

For example, in some embodiments, the positive electrode may further include an additive capable of serving as a sacrificial positive electrode.

A content (e.g., amount) of the positive active material may be from about 90 wt % to about 99.5 wt % based on 100 wt % of the positive active material layer and contents of the binder and the conductive material may each independently be from about 0.5 wt % to about 5 wt % based on 100 wt % of the positive active material layer.

The binder may hold positive active material particles together and bind the positive active material to the positive current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylate styrene-butadiene rubber, epoxy resin, (meth)acrylic resin, polyester resin, and nylon, but embodiments of the present disclosure are not limited thereto.

The conductive material may be utilized to provide conductivity to the electrode and may be any conductive material that does not cause any chemical change in a battery and has conductivity (e.g., is a conductor). Non-limiting examples of the conductive material may include: a carbonaceous material such as natural graphite, artificial graphite, carbon black, acetylene black, Ketjen black, carbon fiber, carbon nanofiber, and carbon nanotube; a metallic material such as copper, nickel, aluminum, and silver, each of which may be utilized in a powder or fiber form; a conductive polymer such as a polyphenylene derivative; or any mixture thereof.

In some embodiments, aluminum (Al) may be utilized as the positive current collector, however, without being limited thereto.

### Negative Electrode

A lithium secondary battery according to one or more embodiments may include a negative electrode, and the negative electrode may include a negative current collector.

### Negative Electrode: Negative Current Collector

In one or more embodiments, the negative current collector may include, for example, a metal substrate. The metal substrate may include a first metal as a main component or may consist of the first metal. A content (e.g., amount) of the first metal contained in the metal substrate may be, for example, 90 wt % or more, 95 wt % or more, 99 wt % or more, or 99.9 wt % or more, based on a total weight of the metal substrate. The metal substrate may be formed of, for example, a material that does not react with lithium, i.e., a material that does not form an alloy and/or a compound with lithium. The first metal may be, for example, copper (Cu), nickel (Ni), stainless steel (SUS), iron (Fe), or cobalt (Co), but embodiments of the present disclosure are not limited thereto, and any materials available in the art as a negative current collectors may also be utilized. The metal substrate may be formed of, for example, one metal selected from those described above or an alloy of two or more metals thereof. The metal substrate may be, for example, in the form of a sheet or a foil. A thickness of the negative current collector may be, for example, from 5 micrometers (μm) to 50 μm, from 10 μm to 50 μm, from 10 μm to 40 μm, or from 10 μm to 30 μm, but is not limited thereto, and may be selected according to required properties of the lithium metal battery.

In one or more embodiments, the negative current collector may further include a coating layer including a second metal and formed on the metal substrate. For example, the negative current collector may include the metal substrate and the coating layer on the metal substrate and including the second metal. The second metal may have a higher Mohs hardness than that of the first metal. For example, because the coating layer including the second metal is harder than the metal substrate including the first metal, deterioration of the metal substrate may be prevented or reduced. For example, a material constituting the metal substrate may have a Mohs hardness of 5.5 or less. The Mohs hardness of the first metal may be, for example, 5.5 or less, 5.0 or less, 4.5 or less, 4.0 or less, 3.5 or less, or 3.0 or less. The Mohs hardness of the first metal may be, for example, from about 2.0 to about 6.0. The Mohs hardness of the material constituting the coating layer may be, for example, 6.0 or more. For example, the Mohs hardness of the second metal may be 6.0 or more, 6.5 or more, 7.0 or more, 7.5 or more, 8.0 or more, 8.5 or more, or 9.0 or more. The Mohs hardness of the second metal may be, for example, from about 6.0 to about 12. If (e.g., when) the Mohs hardness of the second metal is too low, deterioration of the negative current collector may not be inhibited. If (e.g., when) the Mohs hardness of the second metal is too high, processing may not be easy. For example, in one or more embodiments, the second metal may include at least one selected from among titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), and rhodium (Rh). A thickness of the coating layer may be, for example, from 10 nanometers (nm) to 1 μm, from 50 nm to 500 nm, from 50 nm to 200 nm, or from 50 nm to 150 nm.

In one or more embodiments, the negative current collector may include, for example, a base film and a metal layer on one side or both (e.g., two opposite) sides of the base film. The base film may include, for example, a polymer. The polymer may be, for example, a thermoplastic polymer. The polymer may include, for example, polyethyleneterephthalate (PET), polyethylene (PE), polypropylene (PP), polybutyleneterephthalate (PBT), polyimide (PI), or any combination thereof. The base film may be, for example, an insulator. If (e.g., when) the base film includes an insulating thermoplastic polymer, the base film may soften or liquefy in the event of a short circuit to stop the operation of a battery, thereby inhibiting a rapid increase in current. The metal layer may include, for example, copper (Cu), nickel (Ni), stainless steel, iron (Fe), cobalt (Co), or an alloy thereof. The metal layer may act as an electrochemical fuse to be cut if (e.g., when) an overcurrent occurs, thereby preventing or reducing a short circuit. By controlling a thickness of the metal layer, a limiting current and a maximum current may be adjusted. The metal layer may be plated or deposited on the base film. If (e.g., when) the thickness of the metal layer decreases, the limiting current and/or maximum current of the negative current collector decreases, so that stability of the lithium battery may be improved in the event of a short circuit. In one or more embodiments, a lead tab may be added onto the metal layer for connection with the outside. The lead tab may be welded to the metal layer or a metal layer/base film stack structure by ultrasonic welding, laser welding, spot welding, and/or the like. While the base film and/or the metal layer melts during welding, the metal layer may be electrically connected to the lead tab. In some embodiments, a metal chip may further be added between the metal layer and the lead tab for stronger welding between the metal layer and the lead tab. The metal chip may be a chip of the same material as the metal of the metal layer. The metal chip may be, for example, metal foil and metal mesh. In some embodiments, the metal chip may be, for example, an Al foil, a copper foil, or an SUS foil. By disposing the metal chip on the metal layer and performing welding, the lead tab may be welded to a metal chip/metal layer stack structure or a metal chip/metal layer/base film stack structure. While the base film, the metal layer, and/or the metal chip melt during welding, the metal layer or the metal layer/metal chip stack structure may be electrically connected to the lead tab. In some embodiments, a metal chip and/or a lead tab may further be added to a portion of the metal layer. In one or more embodiments, a thickness of the base film may be, for example, from about 1 μm to about 50 μm, from about 1.5 μm to about 50 μm, from about 1.5 μm to about 40 μm, from about 1 μm to about 30 μm, and from about 1 μm to about 20 μm, or from about 1 μm to about 10 μm. If (e.g., when) the thickness of the base film is within the above-described ranges, the weight of an electrode assembly may be reduced more effectively. In one or more embodiments, a melting point of the base film may be, for example, from about 100° C. to about 300° C., from about 100° C. to about 250° C., or from about 100° C. to about 200° C. If (e.g., when) the base film has a melting point within the above-described ranges, the base film may melt during a process of welding the lead tab to be easily bound to the lead tab. In some embodiments, to improve adhesion between the base film and the metal layer, surface treatment such as corona treatment may be performed on the base film. In one or more embodiments, a thickness of the metal layer may be, for example, from about 0.01 μm to about 3 μm, from about 0.1 μm to about 3 μm, from about 0.1 μm to about 2 μm, or from about 0.1 μm to about 1 μm. If (e.g., when) the thickness of the metal layer is within the above-described ranges, stability of the electrode assembly may be obtained while maintaining conductivity thereof. In one or more embodiments, a thickness of the metal chip may be, for example, from about 2 μm to about 10 μm, from about 2 μm to about 7 μm, or from about 4 μm to about 6 μm. If (e.g., when) the thickness of the metal chip is within the above-described ranges, the metal layer may be connected to the lead tab more easily. If (e.g., when) the negative current collector has the above-described structure, the weight of the negative electrode may be reduced, so that energy density of the negative electrode and the lithium battery may be increased.

### Negative Electrode: Lithium Metal Layer

In one or more embodiments, the lithium secondary battery may further include a lithium metal layer disposed between the negative current collector and the electrolyte layer after charging. The lithium metal layer may correspond to a first negative active material layer.

The lithium metal layer may be a metal layer including lithium or a lithium alloy. The lithium metal layer may include lithium or a lithium alloy. The lithium metal layer may serve, for example, as a lithium reservoir. In one or more embodiments, the lithium alloy may be, for example, an Li—Al alloy, an Li—Sn alloy, an Li—In alloy, an Li—Ag alloy, an Li—Au alloy, an Li—Zn alloy, an Li—Ge alloy, or an Li—Si alloy, but embodiments of the present disclosure are not limited thereto, and any lithium alloys commonly available in the art may also be utilized. The metal layer may be formed of one of the alloys alone, lithium, or a combination of one or more suitable types (kinds) of alloys. In some embodiments, the lithium metal layer may be, for example, a plated layer. For example, the lithium metal layer may be plated between the electrolyte layer and the negative current collector during a charging process of the lithium secondary battery.

A thickness of the lithium metal layer is not limited, but may be, for example, from about 1 μm to about 200 μm, from about 1 μm to about 150 μm, from about 1 μm to about 100 μm, from about 1 μm to about 50 μm, from about 1 μm to about 30 μm, from about 1 μm to about 22 μm, or from about 1 μm to about 10 μm. If (e.g., when) the lithium metal layer is too thin, a role of the metal layer as a lithium reservoir may not be performed. If (e.g., when) the lithium metal layer is too thick, volume of the lithium secondary battery may excessively increase and cycle characteristics of the lithium secondary battery may rather be reduced.

The thickness of the lithium metal layer may be, for example, smaller than that of the electrolyte layer. In one or more embodiments, the thickness of the lithium metal layer may be, for example, 70% or less, 60% or less, 50% or less, 40% or less, or 30% or less of the thickness of the electrolyte layer. In some embodiments, the thickness of the lithium metal layer may be, for example, from about 1% to about 70%, from about 1% to about 60%, from about 1% to about 50%, from about 1% to about 40%, or from about 1% to about 30%, of the thickness of the electrolyte layer. A volume change of the lithium secondary battery may be inhibited during charging and discharging because the thickness of the lithium metal layer is smaller than that of the electrolyte layer. As a result, deterioration caused by a volume change of the lithium secondary battery may be inhibited.

The thickness of the lithium metal layer may be, for example, smaller than that of the positive active material layer. In one or more embodiments, the thickness of the lithium metal layer may be, for example, 70% or less, 60% or less, 50% or less, 40% or less, or 30% or less, of the thickness of the positive active material layer. In some embodiments, the thickness of the lithium metal layer may be, for example, from about 1% to from about 70%, from about 1% to about 60%, from about 1% to about 50%, from about 1% to about 40%, or from about 1% to about 30%, of the thickness of the positive active material layer. A volume change of the lithium secondary battery may be inhibited during charging and discharging because the thickness of the lithium metal layer is smaller than that of the positive active material layer. As a result, deterioration caused by a volume change of the lithium secondary battery may be inhibited.

In one or more embodiments, in an X-ray photoelectron spectroscopy (XPS) analysis of the surface of the lithium metal layer, for example, a peak intensity derived from fluorine (F) may be greater than a peak intensity derived from oxygen (O). in some embodiments, in the XPS analysis of the surface of the lithium metal layer, for example, the peak intensity derived from fluorine (F) may be more than 100%, 105% or more, 110% or more, or 120% or more, of the peak intensity derived from oxygen (O). in some embodiments, in the XPS analysis of the surface of the lithium metal layer, for example, the peak intensity derived from fluorine (F) may be more than 100% but not more than 200%, from about 105% to about 200%, from about 110% to about 200%, or from about 120% to about 200%, of the peak intensity derived from oxygen (O). Structural stability of the SEI layer may be improved because the SEI layer formed on the lithium metal layer mainly includes inorganic compound containing fluorine (F). As a result, cycle characteristics of the lithium battery may be improved. In other embodiments, if (e.g., when) the SEI layer formed on the surface of the lithium metal layer mainly include an organic compound containing oxygen (O), structural stability of the SEI layer may deteriorate. The peak derived from fluorine (F) may be, for example, a peak derived from 1s orbital of fluorine (F). The peak intensity derived from oxygen (O) may be, for example, a peak derived from is orbital of oxygen (O).

In one or more embodiments, the lithium metal layer may be plated by charging after assembling the lithium secondary battery, and the lithium metal layer may not be included while the lithium secondary battery is assembled, and thus energy density of the lithium secondary battery may increase. If (e.g., when) the lithium metal layer is additionally disposed by charging after assembling the lithium secondary battery, a region between the negative electrode, i.e., the negative current collector, and the electrolyte layer may be a Li-free region not including lithium (Li) in the early stage of charging or after completely discharging the lithium secondary battery.

The lithium secondary battery according to one or more embodiments may further include a lithium metal layer between the electrolyte layer and the negative current collector and may have a greater peak intensity of fluorine than a peak intensity of oxygen in an XPS analysis of the surface of the lithium metal layer.

For example, in one or more embodiments, the lithium secondary battery may further include a second negative active material layer containing a negative active material between the lithium metal layer and the electrolyte layer and may further include a protective layer disposed on the lithium metal layer.

According to some embodiments, a second negative active material layer including a negative active material may be included between the negative current collector and the electrolyte layer.

### Negative Electrode: Negative Active Material Layer

In one or more embodiments, a negative active material layer may be on the negative current collector.

The negative active material may include at least one of a material allowing reversible intercalation/deintercalation of lithium ions, lithium metal, an alloy of lithium metal, a material allowing doping and undoping of lithium, or a transition metal oxide.

The material allowing reversible intercalation/deintercalation of lithium ions may be a carbonaceous negative active material such as crystalline carbon, amorphous carbon, or any combination thereof. The crystalline carbon may be, for example, graphite such as natural graphite or artificial graphite in an amorphous, plate-like, flake, spherical, or fibrous form, and the amorphous carbon may be, for example, soft carbon or hard carbon, mesophase pitch, carbide, or calcined coke.

The alloy of lithium metal may be an alloy of lithium with one or more metals selected from Na, K, Rb, Cs, Fr, Be, Mg, Ca, Sr, Si, Sb, Pb, In, Zn, Ba, Ra, Ge, Al, and Sn.

The material allowing doping and undoping of lithium may be a Si-based negative active material and/or a Sn-based negative active material. The Si-based negative active material may be silicon, a Si—C composite, SiOₓ (wherein 0<x<2), a Si-Q alloy (wherein Q is an alkali metal, an alkali earth metal, a Group 13 element, a Group 14 element (except for Si), a Group 15 element, a Group 16 element, a transition metal, a rear earth element, and any combination thereof), or any combination thereof. The Sn-based negative active material may be Sn, SnO₂, a Sn-based alloy, or any combination thereof.

The Si—C composite may be a composite of silicon and amorphous carbon. According to one or more embodiments, the Si—C composite may have a structure including silicon particles and amorphous carbon coating layers formed on the surfaces of the silicon particles. For example, in one or more embodiments, the Si—C composite may include a secondary particle (core) formed of silicon primary particles aggregated with each other and an amorphous carbon coating layer (shell) formed on the surface of the secondary particle. The amorphous carbon may also be located between the silicon primary particles, so that the silicon primary particles may be coated with amorphous carbon. The secondary particle may be present in a form being dispersed in an amorphous carbon matrix.

In one or more embodiments, the Si—C composite may further include crystalline carbon. For example, the Si—C composite may include a core including crystalline carbon and silicon particles and an amorphous carbon coating layer formed on the surface of the core.

In one or more embodiments, the Si-base negative active material or the Sn-based negative active material may be utilized in a mixed form with a carbonaceous negative active material.

According to one or more embodiments, the negative electrode for a lithium secondary battery may include a negative current collector and a negative active material layer disposed on the negative current collector. The negative active material layer may include a negative active material and may further include a binder and/or a conductive material.

For example, the negative active material layer may include about 90 wt % to about 99 wt % of the negative active material, about 0.5 wt % to about 5 wt % of the binder, and 0 wt % to about 5 wt % of the conductive material.

The binder may hold the negative active material particles together and bind the negative active material to the negative current collector. As the binder, a non-aqueous binder (e.g., a binder not dispersible in water), an aqueous binder (e.g., a binder dispersible in water), a dry binder, or any combination thereof may be utilized.

The non-aqueous binder may be polyvinylchloride, carboxylated polyvinylchloride, polyvinylfluoride, an ethylene-propylene copolymer, polystyrene, polyurethane, polytetrafluoroethylene, polyvinylidene fluoride, polyethylene, polypropylene, polyamideimide, polyimide, or any combination thereof.

The aqueous binder may be selected from a styrene-butadiene rubber, a (meth)acrylate styrene-butadiene rubber, a (meth)acrylonitrile-butadiene rubber, a (meth)acrylic rubber, a butyl rubber, a fluorine rubber, polyethyleneoxide, polyvinylpyrrolidone, polyepichlorohydrin, polyphosphazene, poly(meth)acrylonitrile, an ethylenepropylenediene copolymer, polyvinylpyridine, chlorosulfonated polyethylene, latex, a polyester resin, a (meth)acrylic resin, a phenol resin, an epoxy resin, polyvinylalcohol, and any combination thereof.

If (e.g., when) the aqueous binder is utilized as the negative electrode binder, a cellulose compound capable of providing viscosity may further be included. As the cellulose compound, a mixture of at least one selected from carboxymethyl cellulose, hydroxypropylmethyl cellulose, methyl cellulose, or an alkali metal salt thereof may be utilized. As the alkali metal, Na, K, or Li may be utilized.

The dry binder, as a polymeric material capable of being fibrillized, may be, for example, polytetrafluoroethylene, polyvinylidene fluoride, a polyvinylidene fluoride-hexafluoropropylene copolymer, polyethyleneoxide, or any combination thereof.

The conductive material may be utilized to provide conductivity to an electrode and may be any conductive material that does not cause any chemical change in a battery and has conductivity (e.g., is a conductor). Non-limiting examples thereof may include: a carbonaceous material such as natural graphite, artificial graphite, carbon black, acetylene black, Ketjen black, carbon fiber, carbon nanofiber, and/or carbon nanotube; a metallic material such as copper, nickel, aluminum, and/or silver, each of which may be utilized in a powder or fiber form; a conductive polymer such as a polyphenylene derivative; or any mixture thereof.

In one or more embodiments, the negative current collector may be selected from a copper thin film, a nickel thin film, a stainless steel thin film, a titanium thin film, a nickel foam, a copper foam, a polymer substrate coated with a conductive metal, and any combination thereof.

### Separator

According to types (kinds) of the lithium secondary battery, a separator may be present between the positive electrode and the negative current collector.

In general, the separator may have a pore diameter of about 0.01 μm to about 10 μm and a thickness of about 5 μm to about 20 μm. As the separator, for example, an olefin-based polymer such as polypropylene, or a sheet or non-woven fabric formed of glass and/or polyethylene may be utilized. If (e.g., when) a solid polymer electrolyte is utilized as the electrolyte, the solid polymer electrolyte may also serve as the separator.

In one or more embodiments, the separator may include a porous substrate and a coating layer including an organic material, an inorganic material, or any combination thereof and disposed on one side or both (e.g., two opposite) sides of the porous substrate.

If (e.g., when) the coating layer (e.g., a ceramic coating layer) is formed, cell performance of the lithium secondary battery may be improved by inhibiting formation of lithium dendrite via rigidity of the ceramic coating layer without considerably increasing resistance of the cell. By including a separator including the above-described ceramic coating layer, heat resistance may increase to improve thermal shrinkage characteristics and separator margin for safety while designing a cell, which may decrease to reduce manufacturing costs of the lithium secondary battery. The growth of dendrite in the negative electrode may be physically inhibited and thus a long-term lifespan may be improved at room temperature and at a high temperature.

The porous substrate may be, for example, a porous film. The porous film may be, for example, a microporous film. The porous film may be, for example, a woven or non-woven fabric. Any porous film utilized in the art for lithium batteries may be utilized. In one or more embodiments, the porous film may include, for example, glass fiber, an olefin resin, a fluorine resin, an ester resin, an imide resin, an acrylic resin, a cellulose resin, or any combination thereof. The olefin resin may include, for example, polyethylene, polypropylene, or any combination thereof. The fluorine resin may include, for example, polyvinylidene fluoride, polytetrafluoroethylene, or any combination thereof. The ester resin may include, for example, polyethyleneterephthalate, polybutyleneterephthalate, or any combination thereof. The imide resin may include, for example, polyamideimide, polyetherimide, or any combination thereof. The acrylic resin may include, for example, polyacrylonitrile, polyacrylate, or any combination thereof. The cellulose resin may include, for example, carboxymethylcellulose, microbial cellulose, plant cellulose, animal cellulose, or any combination thereof.

In some embodiments, the porous substrate may be a polymer film formed of a polyolefin such as polyethylene and/or polypropylene, a polyester such as polyethyleneterephthalate and/or polybutyleneterephthalate, a polymer selected from polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulfide, polyethylenenaphthalate, glass fiber, Teflon, and/or polytetrafluoroethylene, or a copolymer or a mixture of two or more thereof.

The organic material may include a polyvinylidene fluoride-based polymer and/or a (meth)acrylic polymer.

The inorganic material may include one or more inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, aluminum nitride (AlN), silicon carbide (SiC), boron nitride (BoN), BaTiO₃, Pb(Zr,Ti)O₃ (PZT), Pb₁₋ₐLaₐZr_{1-b}Ti_{b}O₃ (PLZT, wherein 0<a<1 and 0<b<1), Pb(Mg_{1/3}Nb_{2/3})O₃—PbTiO₃ (PMN-PT), hafnia (HfO₂), SrTiO₃, SiC, lithium phosphate (Li₃PO₄), lithium titanium phosphate (Li_{c}Ti_{d}(PO₄)₃, wherein 0<c<2 and 0<d<3), lithium aluminum titanium phosphate (Liₐ₁Al_{b1}Ti_{c1}(PO₄)₃, wherein 0<a1<2, 0<b1<1, and 0<c1<3), (LiAlTiP)ₐ₂O_{b2}-type or kind glass such as 14Li₂O-9Al₂O₃-38TiO₂-39P₂O₅ (wherein 0<a2<4 and 0<b2<13), lithium lanthanum titanate (Liₐ₃La_{b3}TiO₃, wherein 0<a3<2 and 0<b3<3), lithium germanium thiophosphate such as Li_{3.25}Ge_{0.25}P_{0.75}S₄ (Liₐ₄Ge_{b4}P_{c2}S_{d}, wherein 0<a4<4, 0<b4<1, 0<c2<1, and 0<d<5), lithium nitride such as Li₃N (Liₐ₅N_{b5}, wherein 0<a5<4 and 0<b5<2), SiS₂-type or kind glass such as Li₃PO₄—Li₂S—SiS₂ (Liₐ₆Si_{b6}S_{c3}, wherein 0<a6<3, 0<b6<2, and 0<c3<4), P₂S₅-type or kind glass such as LiI—Li₂S—P₂S₅ (Liₐ₇P_{b7}S_{c5}, wherein 0<a7<3, 0<b7<3, and 0<c5<7), or any combination thereof, but embodiments of the present disclosure are not limited thereto.

In one or more embodiments, the organic material and the inorganic material may be present in a mixed state in a coating layer or in a stack structure in which an organic material-containing coating layer and an inorganic material-containing coating layer are stacked.

### Lithium Secondary Battery

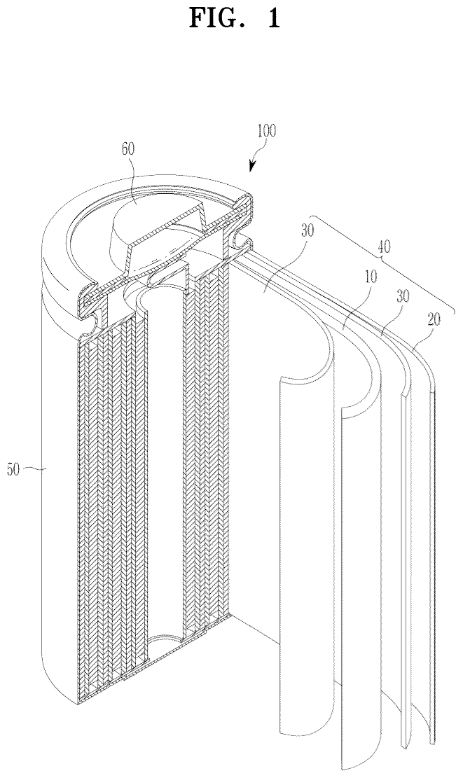

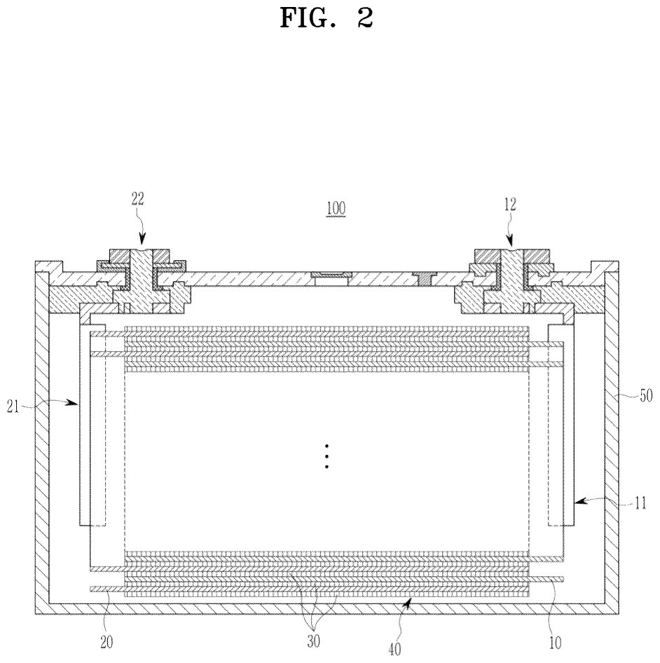

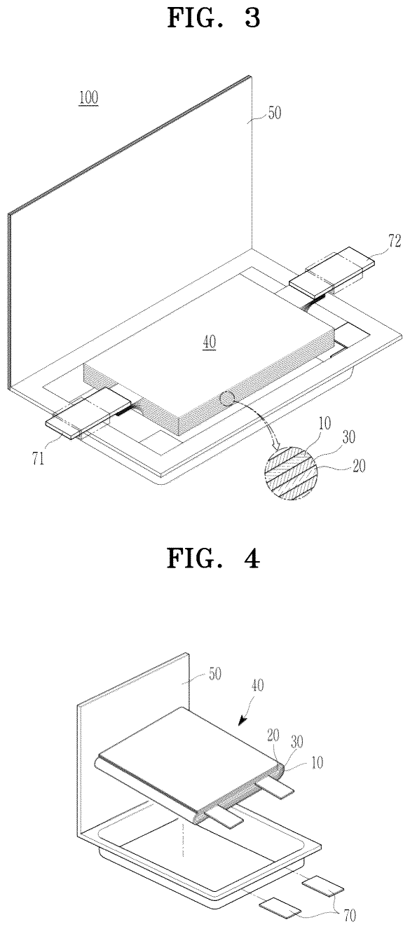

Lithium secondary batteries may be classified into cylindrical-type or kind, rectangular-type or kind, pouch-type or kind, or coin-type or kind. FIGS. 1 to 4 are each a schematic diagram illustrating a lithium secondary battery according to one or more embodiments. FIG. 1 shows a cylindrical-type or kind battery, FIG. 2 shows a rectangular-type or kind battery, and FIG. 3 and FIG. 4 each show a pouch-type or kind battery. Referring to FIGS. 1 to 4, a lithium secondary battery 100 may include a battery assembly 40 including a positive electrode 10, a negative electrode 20, and a separator 30 disposed therebetween and a case 50 accommodating the battery assembly 40. The positive electrode 10, the negative electrode 20, and the separator 30 may be impregnated with the electrolyte according to one or more embodiments of the present disclosure. In some embodiments, the lithium secondary battery 100 may include a sealing member 60 that seals the case 50 as shown in FIG. 1. In some embodiments, as shown in FIG. 2, the lithium secondary battery 100 may include a positive electrode lead tab 11, a positive electrode terminal 12, a negative electrode lead tab 21, and a negative electrode terminal 22. In some embodiments, as shown in FIG. 3 and FIG. 4, the lithium secondary battery 100 may include an electrode tab 70, i.e., a positive electrode tab 71 and a negative electrode tab 72, serving as an electrical passage for inducing a current generated in the electrode assembly 40 to the outside.

The positive electrode 10 may include a positive current collector and a positive active material layer. The negative electrode 20 may include a negative current collector and a negative active material layer.

According to one or more embodiments, the lithium secondary battery including the negative current collector, the positive electrode, and the electrolyte layer disposed therebetween may further include a lithium metal layer on the negative current collector. The lithium metal layer may include a lithium metal foil, lithium metal powder, a lithium alloy foil, lithium alloy powder, or any combination thereof.

The lithium alloy foil and the lithium alloy powder may include lithium and a first metal, and the first metal may be indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), iron, cobalt, chromium, cesium, sodium, potassium, calcium, yttrium, tantalum, hafnium, barium, vanadium, strontium, lanthanum, or any combination thereof.

In some embodiments, the negative electrode may include a negative active material layer between the lithium metal layer and the electrolyte layer, and the negative active material layer may include: a carbonaceous material; a mixture of a carbonaceous material and at least one of a metal or a metalloid; a composite of a carbonaceous material and at least one of a metal or a metalloid; or any combination thereof.

The carbonaceous material may include amorphous carbon (e.g., in a form of particles) having an average particle diameter of about 10 nm to about 100 nm. The carbonaceous material may include carbon black, carbon nanotube, carbon nanofiber, fullerene, activated carbon, carbon fiber, or any combination thereof.

In some embodiments, the negative electrode may further include a protective layer on the lithium metal layer.

The electrolyte may include be a liquid electrolyte, a gel electrolyte, a solid electrolyte, or any combination thereof, and the solid electrolyte may include an oxide-based solid electrolyte, a sulfide-based solid electrolyte, a polymeric solid electrolyte, or any combination thereof.

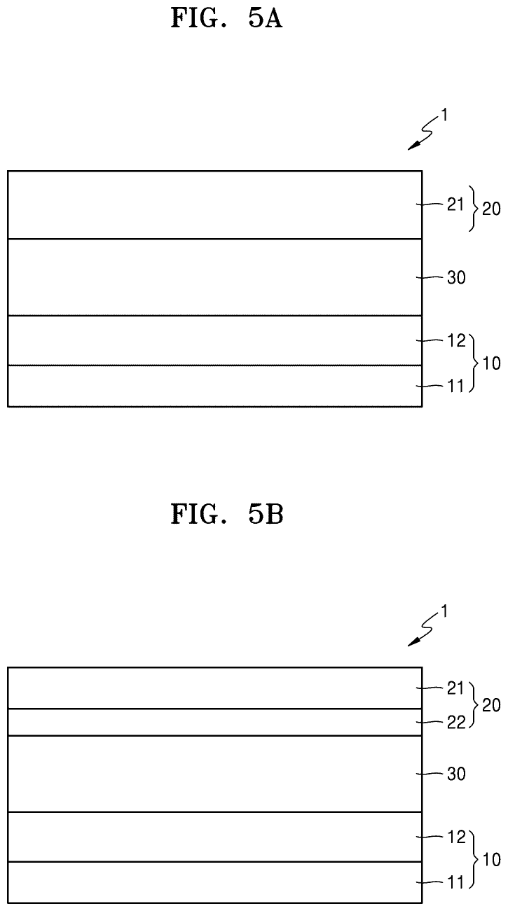

Referring to FIG. 5A, in one or more embodiments, a separator 30 may be stacked on a negative current collector 21. The negative electrode 20 may include the negative current collector 21, and a negative active material layer is absent.

The separator 30 may include an electrolyte including the additive of Formula 1 according to one or more embodiments.

Although the lithium secondary battery 1 (e.g., a lithium metal battery) of FIG. 5A has a structure in which the separator 30 is disposed on the negative current collector 21, the lithium metal battery may also have a structure including an electrolyte layer including the electrolyte according to one or more embodiments instead of the separator 30. The electrolyte may be a solid electrolyte, a gel electrolyte, a liquid electrolyte, or any combination thereof. The solid electrolyte and the gel electrolyte may include an electrolyte including the additive of Formula 1.

The positive electrode 10 may be disposed on the separator 30. The positive electrode 10 may include a positive active material layer 12 and a positive current collector 11.

In some embodiments, an electrolyte may further be included between the separator 30 and the positive electrode 10. The electrolyte may be a gel electrolyte, a solid electrolyte, a liquid electrolyte, or any combination thereof.

In some embodiments, a protective layer may further be disposed on the negative current collector 21.

In pores of the separator 30 including the porous substrate, a liquid electrolyte may be contained, or

a gel-type or kind polymer electrolyte including the liquid electrolyte and a crosslinking polymer may be contained.

The liquid electrolyte may include a lithium salt and an organic solvent (i.e., a non-aqueous organic solvent).

As shown in FIG. 5B, in one or more embodiments, the lithium metal layer 22 may be disposed between the negative current collector 21 and the separator 30.

According to one or more embodiments, the lithium metal layer 22 may be provided and located while the lithium metal battery is assembled. According to other embodiments, lithium metal may be plated after charging, and thus a negative active material layer may be included therein. The negative active material layer may be a plated lithium layer.

The lithium metal layer 22 may include lithium metal or a lithium alloy.

The lithium metal layer may have a thickness of about 1 μm to about 500 μm or about 10 μm to about 500 μm. If (e.g., when) the thickness of the lithium metal layer is within the ranges described above, cycle characteristics of the lithium metal battery may be improved without a decrease in energy density.

In one or more embodiments, the negative active material layer may further be included between the negative current collector and the separator. The negative active material layer may be disposed between the lithium metal layer and the separator.

According to one or more embodiments, the negative active material layer may include: a carbonaceous material; a mixture of a carbonaceous material and at least one of a metal or a metalloid; a composite of a carbonaceous material and at least one of a metal or a metalloid; or any combination thereof.

The carbonaceous material may include amorphous carbon having an average particle diameter of about 10 nm to about 100 nm. The carbonaceous material may include carbon black (CB), acetylene black (AB), furnace black (FB), Ketjen black (KB), graphene, or any combination thereof.

In some embodiments, the negative active material layer may be a lithium metal foil, lithium metal powder, a lithium alloy foil, lithium alloy powder, or any combination thereof, and the lithium alloy foil and lithium alloy powder may include lithium and a first metal.

The first metal may be indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), iron, cobalt, chromium, cesium, sodium, potassium, calcium, yttrium, tantalum, hafnium, barium, vanadium, strontium, lanthanum, or any combination thereof.

In one or more embodiments, the lithium metal layer 22 may include, for example, a lithium foil, lithium powder, or any combination thereof. The lithium foil may include, for example, a lithium metal foil, a lithium alloy foil, or any combination thereof. The lithium powder may include lithium metal powder, lithium alloy powder, or any combination thereof. The lithium alloy is an alloy of lithium and a metal alloyable with lithium, for example, a lithium-silver alloy, a lithium-zinc alloy, a lithium-magnesium alloy, or a lithium-tin alloy. In some embodiments, the negative active material layer including the lithium metal foil may be, for example, a lithium metal layer. In some embodiments, the negative active material layer including the lithium alloy foil may be, for example, a lithium alloy layer. The negative active material layer including lithium metal powder and/or lithium alloy powder may be introduced onto the negative current collector by applying a slurry including lithium powder and a binder thereto. The binder may be a fluorine-based binder, such as polyvinylidene fluoride (PVDF). In some embodiments, the negative active material layer may not include (e.g., may exclude) a carbonaceous negative active material. Therefore, the negative active material layer may be formed of a metallic negative active material.

The negative current collector may be formed of, for example, a material that does not react with lithium, i.e., a material that does not form an alloy and a compound with lithium. The material constituting the negative current collector may be, for example, copper (Cu), stainless steel, titanium (Ti), iron (Fe), cobalt (Co), and nickel (Ni), but is not limited thereto, and any materials available in the art as electrode current collectors may also be utilized. The negative current collector may be formed of one metal selected from those described above or an alloy or a coating material of two or more metals selected therefrom. The negative current collector may be, for example, in the form of a plate or a foil.

In lithium metal battery according to one or more embodiments, a protective layer may further be introduced between the negative current collector and the separator. In some embodiments, the protective layer may further be introduced between the negative active material layer and the separator.

The protective layer may include, for example, a polymer such as polyvinylalcohol, polyimide, a vinylidene fluoride-hexafluoropropylene copolymer, polyvinylidene fluoride, carboxymethylcellulose, and/or styrene butadiene rubber, or a polymer and an inorganic filler. The inorganic filler may be, for example, SiO₂, Al₂O₃, Al(OH)₃, AlO(OH), TiO₂, BaTiO₃, ZnO₂, Mg(OH)₂, aluminum nitride (AlN), silicon carbide (SiC), boron nitride (BoN), or any combination thereof. If (e.g., when) the protective layer is further introduced as described above, contact between lithium and the electrolytic solution may be minimized or reduced to reduce side reactions, and substantially uniform flows of lithium ions are formed over the entire electrode, so that the growth of lithium dendrite may be inhibited.

The protective layer may have, for example, a thickness of about 1 μm to about 20 μm.

In one or more embodiments, the negative active material layer may include a negative active material and a binder.

The negative active material may be, for example, in the form of particles. The negative active material in the form of particles may have an average particle diameter of, for example, about 10 nm to about 4 μm, about 10 nm to about 1 μm, about 10 nm to about 500 nm, about 10 nm to about 100 nm, or about 20 nm to about 80 nm. If (e.g., when) the average particle diameter of the negative active material is within the ranges described above, reversible plating and/or dissolution of lithium may occur more easily during a charge/discharge process. The average particle diameter of the negative active material may be, for example, a median diameter D50 measured utilizing a laser particle size analyzer.

In one or more embodiments, the negative active material may include, for example, at least one selected from among a carbonaceous negative active material and a metal or metalloid negative active material. The carbonaceous negative active material may be, for example, amorphous carbon. The carbonaceous negative active material may be, for example, carbon black (CB), acetylene black (AB), furnace black (FB), Ketjen black (KB), graphene, or any combination thereof, but embodiments of the present disclosure are not limited thereto, and any carbonaceous materials classified as amorphous carbon may also be utilized. Amorphous carbon may be carbon that does not have crystallinity or has very low crystallinity and may be distinguished from crystalline carbon or graphite-based carbon. The metal or metalloid negative active material may include at least one selected from among gold (Au), platinum (Pt), palladium (Pd), silicon (Si), silver (Ag), aluminum (Al), bismuth (Bi), tin (Sn), and zinc (Zn), but embodiments of the present disclosure are not limited thereto, and any suitable metal or metalloid negative active materials that form an alloy or a compound with lithium may also be utilized. For example, nickel (Ni) does not form an alloy with lithium, and thus Ni is not a metal negative active material. The negative active material layer may include one of these negative active materials or a mixture of a plurality of different negative active materials. In some embodiments, the negative active material layer may include, for example, a mixture of amorphous carbon and at least one selected from among gold (Au), platinum (Pt), palladium (Pd), silicon (Si), silver (Ag), aluminum (Al), bismuth (Bi), tin (Sn), and zinc (Zn). A mixing ratio of the mixture may be, for example, from 10:1 to 1:2, from 10:1 to 1:1, from 7:1 to 1:1, from 5:1 to 1:1, or from 4:1 to 2:1. For example, in some embodiments, the negative active material included in the negative active material layer may include a mixture of first particles formed of amorphous carbon and second particles formed of a metal or metalloid. The metal may include, for example, gold (Au), platinum (Pt), palladium (Pd), silicon (Si), silver (Ag), aluminum (Al), bismuth (Bi), tin (Sn), zinc (Zn), or any combination thereof. An amount of the second particles may be from about 8 wt % to about 60 wt %, from about 10 wt % to about 50 wt %, from about 15 wt % to about 40 wt %, or from about 20 wt % to about 30 wt % based on a total weight of the mixture. If (e.g., when) the amount of the second particles is within the ranges described above, cycle characteristics of the lithium metal battery may further be improved.

The binder included in the negative active material layer may be, for example, a styrene butadiene rubber (SBR), polytetrafluoroethylene, polyvinylidene fluoride, polyethylene, a vinylidene fluoride/hexafluoropropylene copolymer, polyacrylonitrile, or polymethylmethacrylate, but embodiments of the present disclosure are not limited thereto, and any binders available in the art may also be utilized. The binder may be utilized alone or as a combination of a plurality of different binders. If (e.g., when) the negative active material layer does not include a binder, the negative active material layer may be easily separated from the ceramic coating layer or the negative current collector 21. An amount of the binder included in the negative active material layer may be, for example, from 1 wt % to 20 wt % based on a total weight of the negative active material layer.

If (e.g., when) the negative active material layer is present, the thickness of the negative active material layer may be, for example, from about 1% to about 50%, from about 1% to about 30%, from about 1% to about 10%, or from about 1% to about 5%, of the thickness of the positive active material layer. If (e.g., when) the negative active material layer is too thin, lithium dendrite formed between the negative active material layer and the negative current collector may disintegrate the negative active material layer, making it difficult to improve cycle characteristics of the lithium metal battery. If (e.g., when) the negative active material layer is too thick, energy density of the lithium metal battery including the negative electrode 20 may decrease, making it difficult to improve cycle characteristics of thereof.

### Method of Manufacturing Lithium Secondary Battery

The lithium secondary battery according to one or more embodiments may be manufactured by: a process of preparing a negative electrode; a process of preparing a positive electrode; a process of preparing an assembly by utilizing the positive electrode and the negative electrode; and a process of providing the assembly with an electrolyte including the additive represented by Formula 1 according to one or more embodiments.

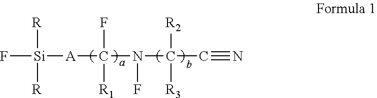

In Formula 1, A may represent a chemical bond or —(CH₂)ₖ— (wherein k is an integer from 1 to 3),
a and b may each independently be 0 or an integer of 1 to 3,
a and b may not be both integers from 1 to 3 simultaneously (e.g., at least one of a or b may be (e.g., has to be) 0), and
R, R₁, R₂, and R₃ may each independently be hydrogen, a C1-C10 alkyl group, or F.

The assembly may be prepared by disposing a separator between the positive electrode and the negative electrode.

The electrolyte may further include a solid electrolyte, a liquid electrolyte, a gel electrolyte, or any combination thereof. The solid electrolyte may include an oxide-based solid electrolyte, a sulfide-based solid electrolyte, a polymer solid electrolyte, or any combination thereof.

The gel electrolyte may be formed by injecting a gel-type or kind polymer electrolyte-forming composition including a polymerizable monomer, a liquid electrolyte, and an initiator into the assembly and crosslinking the composition. The process of injecting the gel-type or kind polymer electrolyte-forming composition into the assembly may be performed by impregnating in a vacuum such that the composition sufficiently penetrates into pores of the porous substrate of the separator.

The gel-type or kind polymer electrolyte may be formed of the gel-type or kind polymer electrolyte-forming composition by curing utilizing heat, UV rays, or high-energy radiation (electron beams and γ-rays). The curing reaction utilizing heat may be performed at a temperature of about 40° C. to about 120° C., for example, about 50° C. to about 90° C., for about 30 minutes to about 120 minutes.

The heat treatment may vary according to types (kinds) of the polymerizable monomer but may be performed, for example, at a temperature of about 40° C. to about 120° C.

The gel-type or kind polymer electrolyte-forming composition may further include a crosslinking agent, a temperature-sensitive initiator, and/or the like to assist crosslinking of the crosslinking monomer. Any crosslinking agents and initiators available in the art may be utilized without limitation.

As the crosslinking monomer, trimethylolpropane triacrylate, and/or the like may be utilized.

As the initiator, for example, benzoin ethylether, and/or the like may be utilized.

The crosslinking agent and the initiator may be utilized within amounts utilized in the art. In some embodiments, a content (e.g., amount) of the initiator may be from about 0.1 parts by weight to about 5 parts by weight or from about 0.2 parts by weight to about 3 parts by weight based on 100 parts by weight of a total content (e.g., amount) of the monomer forming the crosslinking polymer. By utilizing the gel-type or kind polymer electrolyte prepared as described above, an ionic conductivity may be maintained at a value similar to an ionic conductivity of a liquid electrolytic solution. The gel-type or kind polymer electrolyte contained in the positive electrode and the negative electrode may inhibit leakage of the liquid electrolytic solution. The electrolytic solution may be trapped in a polymer matrix of the gel-type or kind polymer electrolyte and remained in the polymer matrix, and thus migration of lithium ions may be assisted thereby. Due to excellent or suitable electrochemical properties of the polymer, degradation of the electrolytic solution may be inhibited in a range of about −1 V to about 5 V.

In one or more embodiments, the gel-type or kind polymer electrolyte may have an ionic conductivity of 0.26 mS/cm or more, for example, about 0.26 mS/cm to about 1.0 mS/cm or about 0.3 mS/cm to about 1.0 mS/cm.

The lithium secondary battery according to one or more embodiments of the present disclosure may be applied to vehicles, smart phones, and/or one or more suitable types (kinds) of electronic devices, but the present disclosure is not limited thereto.

Hereinafter, one or more embodiments will be described in more detail with reference to the following examples and comparative examples. However, these examples are not intended to limit the purpose and scope of the one or more embodiments.

### Preparation of Electrolyte

### Preparation Example 1: Electrolyte (Additive of Formula 2 (5 wt %), 1 M LiPF₆, EC:EMC:DMC (4:3:3))

1 M LiPF₆ and an additive of Formula 2 were added to a mixed solvent of ethylene carbonate (EC), ethylmethyl carbonate (EMC), and dimethyl carbonate (DMC) mixed in a weight ratio of 4:3:3 to prepare an electrolyte. A content (e.g., amount) of the additive was 2 wt % based on 100 wt % of the (liquid) electrolyte.

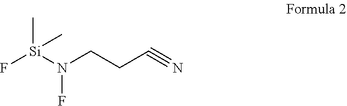

### Preparation Example 2: Electrolyte (Additive of Formula 3 (2 wt %), 1 M LiPF₆, EC:EMC:DMC (4:3:3))

An electrolyte was prepared in substantially the same manner as in Preparation Example 1, except that an additive of Formula 3 was utilized instead of the additive of Formula 2.

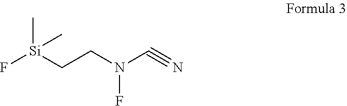

### Preparation Example 3: Electrolyte (Additive of Formula 4 (2 wt %), 1 M LiPF₆, EC:EMC:DMC (4:3:3))

An electrolyte was prepared in substantially the same manner as in Preparation Example 1, except that an additive of Formula 4 was utilized instead of the additive of Formula 2.

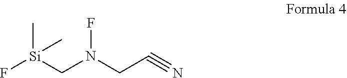

### Preparation Example 4: Electrolyte (Additive of Formula 5 (2 wt %), 1 M LiPF₆, EC:EMC:DMC (4:3:3))

An electrolyte was prepared in substantially the same manner as in Preparation Example 1, except that an additive of Formula 5 was utilized instead of the additive of Formula 2.

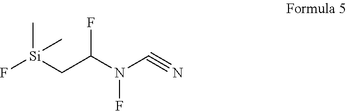

### Preparation Example 5: Electrolyte (Additive of Formula 6 (2 wt %), 1 M LiPF₆, EC:EMC:DMC (4:3:3))

An electrolyte was prepared in substantially the same manner as in Preparation Example 1, except that an additive of Formula 6 was utilized instead of the additive of Formula 2.

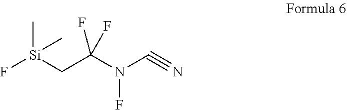

### Preparation Example 6: Electrolyte (Additive of Formula 2 (10 wt %), 1 M LiPF₆, EC:EMC:DMC (4:3:3))

An electrolyte was prepared in substantially the same manner as in Preparation Example 1, except that the content (e.g., amount) of the additive of Formula 2 was 10 wt %.

### Preparation Example 7: Electrolyte (Additive of Formula 2 (1 wt %), 1 M LiPF₆, EC:EMC:DMC (4:3:3))

An electrolyte was prepared in substantially the same manner as in Preparation Example 1, except that the content (e.g., amount) of the additive of Formula 2 was 1 wt %.

### Preparation Example 8: Electrolyte (Additive of Formula 2 (2 wt %), FEC and DEC in Weight Ratio of 42:48, 0.6 M LiDFOB, and 0.6 M LiBF₄)

0.6 M lithium difluoro(oxalate)borate (LiDFOB), 0.6 M LiBF₄, and the additive of Formula 2 were added to a mixed solvent of fluoroethylene carbonate (FEC) and diethyl carbonate (DEC) mixed in a weight ratio of 45:55 to prepare an electrolyte. A content (e.g., amount) of the additive was 2 wt % based on 100 wt % of a liquid electrolyte. A content (e.g., amount) of FEC was 46 wt %, a content (e.g., amount) of the additive was 2 wt %, and a content (e.g., amount) of DEC was 52 wt % based on 100 wt % of a total amount of the FEC, the additive, and DEC.

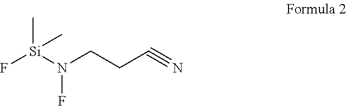

### Comparative Preparation Examples 1 to 16

Electrolytes were each prepared in substantially the same manner as in Preparation Example 1, except that compounds represented by Formulae 9 to 24 were utilized, respectively, as the electrolyte additive.

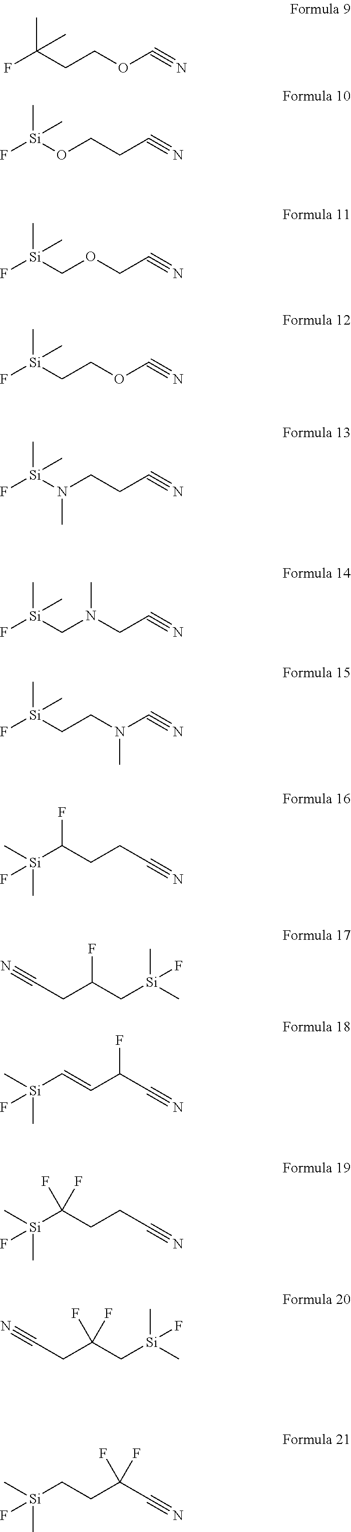

The electrolytes of Comparative Preparation Examples 2 to 16 each had the same amounts of the lithium salt and the organic solvent as those of the electrolyte of Comparative Preparation Example 1.

As the lithium secondary battery, a lithium metal battery was utilized.

### Manufacture of Lithium Metal Battery

### Example 1: Electrolyte (Additive of Formula 2 (2 wt %), 1 M LiPF₆, EC:EMC:DMC (4:3:3))

A 20 μm-thick polyethylene single layer, as a separator, was stacked on one side of a 10 μm-thick copper foil, as a negative current collector, and a positive electrode was stacked on the other side of the separator to prepare a stack structure. The electrolyte of Preparation Example 1 as a liquid electrolyte was injected into the prepared stack structure to prepare a lithium metal battery.

The lithium metal battery had a positive electrode/separator/negative current collector structure.

Li_{1.04}Ni_{0.88}Co_{0.1}Al_{0.02}O₂ powder and a carbonaceous conductive material (Super-P; Timcal Ltd.) were uniformly mixed in a weight ratio of 90:5, and a polyvinylidene fluoride (PVDF) binder solution was added thereto to satisfy a weight ratio of the active material:the carbonaceous conductive material:the binder=95.5:2:2.5 to prepare a positive active material slurry.

The prepared positive active material slurry was applied onto a 15 μm-thick Al substrate by utilizing a coater, dried at 120° C. under a reduced pressure, and rolled utilizing a roll press into a sheet form to prepare a positive electrode.

### Example 2: Electrolyte (Additive of Formula 3 (2 wt %), 1 M LiPF₆, EC:EMC:DMC (4:3:3))

A lithium metal battery was prepared in substantially the same manner as in Example 1, except that the electrolyte of Preparation Example 2 was utilized as the liquid electrolyte.

### Example 3: Electrolyte (Additive of Formula 4 (2 wt %), 1 M LiPF₆, EC:EMC:DMC (4:3:3))

A lithium metal battery was prepared in substantially the same manner as in Example 1, except that the electrolyte of Preparation Example 3 was utilized as the liquid electrolyte.

### Example 4: Electrolyte (Additive of Formula 5 (2 wt %), 1 M LiPF₆, EC:EMC:DMC (4:3:3))

A lithium metal battery was prepared in substantially the same manner as in Example 1, except that the electrolyte of Preparation Example 4 was utilized as the liquid electrolyte.

### Example 5: Electrolyte (Additive of Formula 6 (2 wt %), 1 M LiPF₆, EC:EMC:DMC (4:3:3))

A lithium metal battery was prepared in substantially the same manner as in Example 1, except that the electrolyte of Preparation Example 5 was utilized as the liquid electrolyte.

### Example 6: Electrolyte (Additive of Formula 2 (10 wt %), 1 M LiPF₆, EC:EMC:DMC (4:3:3))

A lithium metal battery was prepared in substantially the same manner as in Example 1, except that the electrolyte of Preparation Example 6 was utilized as the liquid electrolyte.

### Example 7: Electrolyte (Additive of Formula 2 (5 wt %), 1 M LiPF₆, EC:EMC:DMC (4:3:3))

A lithium metal battery was prepared in substantially the same manner as in Example 1, except that the electrolyte of Preparation Example 7 was utilized as the liquid electrolyte.

### Example 8: Electrolyte (Additive of Formula 2 (2 wt %), FEC and DEC in a Weight Ratio of 42:48, 0.6 M LiDFOB, and 0.6 M LiBF₄)

A 20 μm-thick polyethylene single layer, as a separator, was stacked on one side of a 10 μm-thick copper foil, as a negative current collector, and a positive electrode was stacked on the other side of the separator to prepare a stack structure. The liquid electrolyte of Preparation Example 8 was injected into the prepared stack structure to prepare a lithium metal battery.

The lithium metal battery had a positive electrode/separator/negative current collector structure.

Li_{1.04}Ni_{0.88}Co_{0.1}Al_{0.02}O₂ powder and a carbonaceous conductive material (Super-P; Timcal Ltd.) were uniformly mixed in a weight ratio of 90:5, and a polyvinylidene fluoride (PVDF) binder solution was added thereto to satisfy a weight ratio of the active material:the carbonaceous conductive material:the binder=95.5:2:2.5 to prepare a positive active material slurry.

The prepared positive active material slurry was applied onto a 15 μm-thick Al substrate by utilizing a coater, dried at 120° C. under a reduced pressure, and rolled utilizing a roll press into a sheet form to prepare a positive electrode.

### Comparative Examples 1 to 16

Lithium metal batteries were each manufactured in substantially the same manner as in Example 1, except that the electrolytes of Comparative Preparation Examples 1 to 16 were utilized as the liquid electrolyte, respectively.

### Evaluation Example 1: Oxidation Potential

Each of the electrolytes of Preparation Examples 1 to 5 and the electrolytes of Comparative Preparation Examples 1 to 16 was utilized with a Pt electrode. While increasing an oxidation potential by 5 mV, a potential at which oxidation current was detected was measured. Measurement results of oxidation potentials are shown in Table 1.

### Evaluation Example 2: Storage at High Temperature (HF Concentration)

To evaluate stability of each of electrolytes of the lithium secondary batteries according to Examples 1 to 5 and Comparative Examples 1 to 16, each of the lithium secondary batteries was left standing at 60° C. in a state of charge (SOC, 100%) for 7 days, and a concentration of hydrogen fluoride (HF) after storage (left standing) at a high temperature (60° C.) was evaluated utilizing the following method.

400 ppm of H₂O was added to each of the electrolytes of Preparation Examples 1 to 5 and the electrolytes of Comparative Preparation Exampled 1 to 16. A peak current was measured at an HF reduction potential of 2.6 V and HF concentration was measured by utilizing the Randles-Sevcik equation. HF concentrations were each measured and results thereof are shown in Table 1.

TABLE 1

| | | After storage at |
|---|---|---|
| | Oxidation | high temp. HF |
| | potential | concentration |
| Category | (V) | (ppm) |
| Example 1 | 4.522 | 12 |
| Example 2 | 4.674 | 8 |
| Example 3 | 4.892 | 9 |
| Example 4 | 5.31 | 4 |
| Example 5 | 5.32 | 3 |
| Comparative | 5.28 | 448 |
| Example 1 | | |
| Comparative | 5.16 | 360 |
| Example 2 | | |
| Comparative | 4.52 | 336 |
| Example 3 | | |
| Comparative | 5.00 | 128 |
| Example 4 | | |
| Comparative | 4.09 | 568 |
| Example 5 | | |
| Comparative | 3.70 | 772 |
| Example 6 | | |
| Comparative | 3.70 | 772 |
| Example 6 | | |
| Comparative | 4.28 | 712 |
| Example 7 | | |
| Comparative | 4.75 | 252 |
| Example 8 | | |
| Comparative | 5.07 | 764 |
| Example 9 | | |
| Comparative | 4.92 | 304 |
| Example 10 | | |
| Comparative | 4.75 | 392 |
| Example 11 | | |
| Comparative | 4.89 | 396 |
| Example 12 | | |
| Comparative | 4.99 | 98 |
| Example 13 | | |
| Comparative | 4.91 | 684 |
| Example 14 | | |
| Comparative | 4.92 | 824 |
| Example 15 | | |
| Comparative | 5.04 | 384 |
| Example 16 | | |

Based on Table 1, the electrolytes of Examples 4 and 5 had improved oxidation resistance due to greater oxidation potentials than that of the electrolytes of Comparative Examples 1 to 16 so as to be efficiently utilized as high-voltage solvents. The electrolytes of Examples 1 to 3 had improved oxidation resistance due to greater oxidation potential than that of the electrolytes of Comparative Examples 3 and 5 to 7.

However, it was confirmed that it is difficult to apply the electrolytes of Comparative Preparation Examples 1, 2, 4, 8, and 9 to 16 due to high concentrations of HF after storage at a high temperature although the oxidation potentials of the electrolytes were high.

It was also confirmed that the concentration of HF was significantly reduced by the additives of the electrolytes of Examples 1 to 5 utilized in the lithium metal batteries after storage at a high temperature compared to the additives of the electrolytes of Comparative Examples 1 to 16. Based thereon, it was confirmed that the additives of the electrolytes of Examples 1 to 5 had excellent or suitable effects on inhibiting side reactions with an electrolytic solution during storage at a high temperature.

### Evaluation Example 3: Lifespan at High Temperature (45° C.)

Charging and discharging characteristics of each of the lithium metal batteries of Examples 1 to 5 and Comparative Examples 1 and 7 were evaluated under the following conditions.

The lithium metal battery was charged at 45° C. at a constant current of 0.1 C rate until a voltage reached 4.3 V (vs. Li) and the charging process was cut-off at a rate of 0.05 C rate in a constant voltage mode while the voltage of 4.3 V was maintained. Subsequently, the lithium battery was discharged with a constant current of 0.1 C rate until the voltage reached 3.0 V (vs. Li) during discharging (formation cycle).

The lithium metal battery that had undergone the formation cycle was charged with a constant current with a current of 0.2 C rate at 45° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 0.5 C rate until the voltage reached 3.0 V (vs. Li) during discharging (1^{st} cycle). This cycle was repeated to a 200^{th} cycle under the same conditions.

The lithium metal batteries were each rested for 10 minutes after every charging/discharging cycle. The number of cycles was evaluated and the results are shown in Table 3.

The number of cycles refers to a number of cycles required to reduce a discharge capacity to 90% of a standard capacity after a second cycle. As the number of cycles increases, it was considered to have excellent or suitable lifespan characteristics.

TABLE 2

| Category | Lifespan (SOH90@) |
|---|---|
| Example 1 | 80 |
| Example 2 | 72 |
| Example 3 | 79 |
| Example 4 | >150 |
| Example 5 | >150 |
| Comparative Example 1 | 60 |
| Comparative Example 7 | 45 |

As shown in Table 2, the lithium metal batteries of Comparative Examples 1 and 7 had decreased lifespans due to side reactions between lithium and the electrolyte caused by the growth of dendrite.

However, the lithium metal batteries of Examples 1 to 5 each had increased lifespans unlike the lithium metal batteries of Comparative Examples 1 and 7.

Although embodiments are described above with reference to illustrated drawing, the present disclosure is not limited thereto. It is obvious that one or more suitable alternations and modifications will be apparent to one or ordinary skill in the art to which this application belongs within protection coverage of the present disclosure.

According to one or more aspects of the present disclosure, an electrolyte for a lithium secondary battery having improved oxidation resistance due to high oxidation potential may be provided and a lithium secondary battery having improved performance at a high temperature may be provided because lifespan characteristics of the lithium secondary batter may be improved by applying the electrolyte to a high-voltage positive electrode and HF, as a cause of deterioration, may be removed.

In present disclosure, “not include (or not including) a or any ‘component’” “exclude (or excluding) a or any ‘component’”, “‘component’-free”, “free of ‘component’” and/or the like refers to that the “component” not being added, selected or utilized as a component in the composition, but the “component” of less than a suitable amount may still be included due to other impurities and/or external factors.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The battery module, battery pack, battery management system, electric vehicle, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the present disclosure as defined by the appended claims and equivalents thereof.

What is claimed is:

1. A lithium secondary battery comprising
a positive electrode, a negative current collector, and an electrolyte between the positive electrode and the negative current collector,
wherein the electrolyte comprises an additive represented by Formula 1: 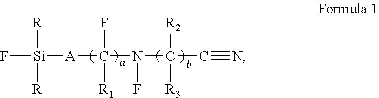
wherein, in Formula 1, A represents a chemical bond or —(CH₂)ₖ— (wherein k is an integer from 1 to 3),
a and b are each independently 0 or an integer from 1 to 3,
at least one of a or b is 0, and
R, R₁, R₂, and R₃ are each independently hydrogen, a C1-C10 alkyl group, or F.

2. The lithium secondary battery as claimed in claim 1, wherein the additive represented by Formula 1 comprises at least one selected from compounds represented by Formulae 2 to 8:

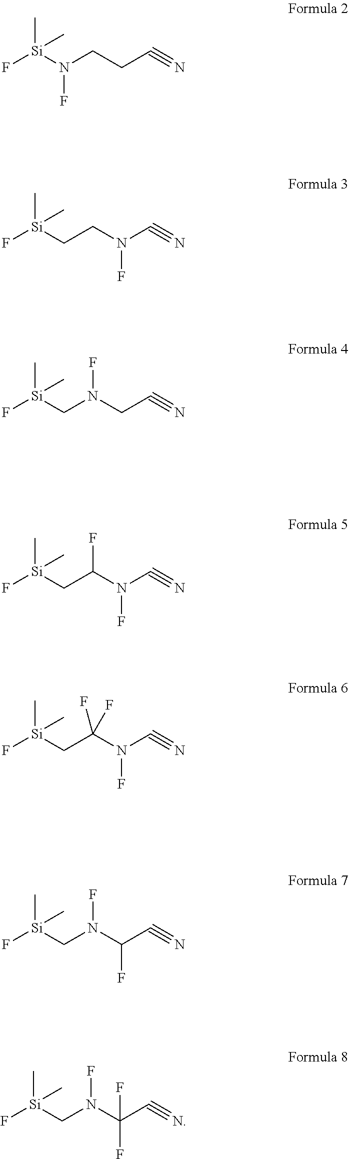

3. The lithium secondary battery as claimed in claim 1, wherein an amount of the additive represented by Formula 1 is from about 0.1 wt % to about 10 wt % based on a total weight of the electrolyte.

4. The lithium secondary battery as claimed in claim 1, wherein the electrolyte has an oxidation potential of about 4.5 V to about 5.4 V.

5. The lithium secondary battery as claimed in claim 1, wherein the electrolyte comprises a lithium salt,
the lithium salt has a concentration of about 0.01 M to about 5.0 M, and
the lithium salt comprises at least one selected from among
LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, lithium bis(fluorosulfonyl)imide, LiC₄F₉SO₃, LiN(CₓF₂ₓ₊₁SO₂)(C_{y}F_{2y+1}SO₂) (wherein x and y are each independently an integer from 1 to 20), lithium trifluoromethanesulfonate, lithium tetrafluoroethanesulfonate, lithium difluorobis(oxalato)phosphate, lithium bis(oxalato)borate, and combinations thereof.

6. The lithium secondary battery as claimed in claim 1, wherein the electrolyte comprises a lithium salt,
the lithium salt comprises a first lithium salt and a second lithium salt, the first lithium salt and the second lithium salt each independently comprising a fluorine-containing borate-based lithium salt, and
the fluorine-containing borate-based lithium salt comprises LiBF₄, LiBF₃(C₂F₅), one of compounds represented by Formulae 1-1 to 1-12, or any combination thereof:

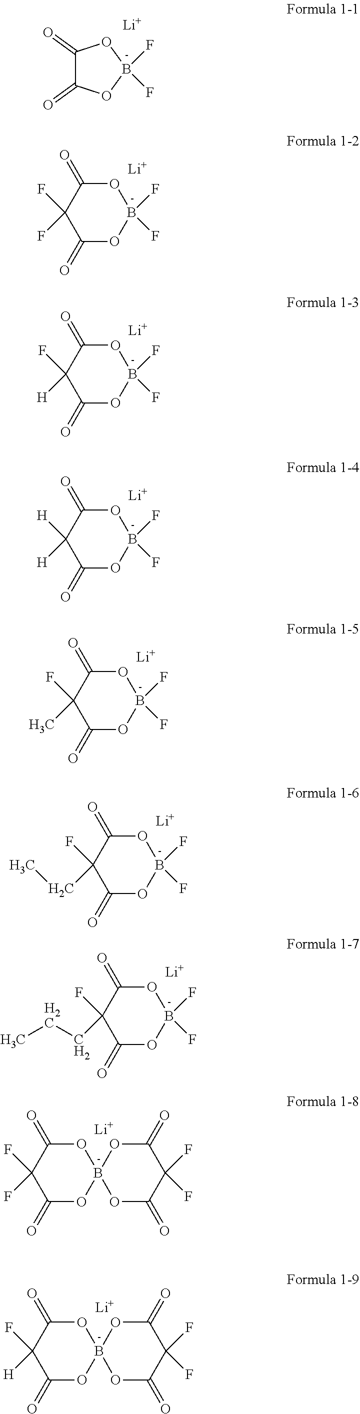

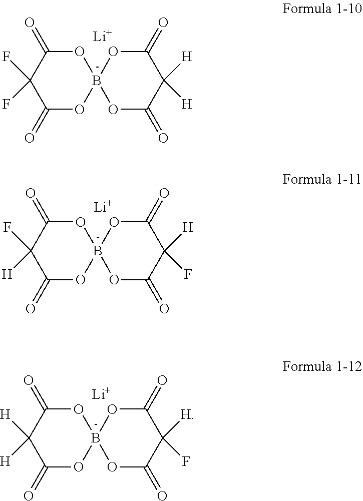

7. The lithium secondary battery as claimed in claim 6, wherein the first lithium salt comprises LiBF₄, and the second lithium salt comprises a compound selected from the compounds represented by Formulae 1-1 to 1-12,
a concentration of the first lithium salt and the second lithium salt is more than 0 M but not more than 1.2 M, and
a molar ratio of the first lithium salt to the second lithium salt is from about 1:9 to about 9:1.

8. The lithium secondary battery as claimed in claim 1, wherein the electrolyte comprises a lithium salt,
the lithium salt comprises lithium difluoro(oxalato)borate and lithium tetrafluoroborate, and
a mixing weight ratio of the lithium difluoro(oxalato)borate to the lithium tetrafluoroborate is from about 1:2 to about 1:0.3.

9. The lithium secondary battery as claimed in claim 1, wherein the electrolyte comprises a non-aqueous organic solvent, and
the non-aqueous organic solvent comprises at least one selected from among fluoroethylene carbonate, dimethyl carbonate, butylene carbonate, diethyl carbonate, methylethyl carbonate, methylpropyl carbonate, ethylpropyl carbonate, methylisopropyl carbonate, dipropyl carbonate, dibutyl carbonate, propylene carbonate, ethylene carbonate, fluoroethylene carbonate, vinylene carbonate, vinylethylene carbonate, butylene carbonate, ethyl propionate, ethyl butyrate, dimethylsulfoxide, dimethylformamide, dimethylacetamide, γ-valerolactone, γ-butyrolactone, and tetrahydrofuran.

10. The lithium secondary battery as claimed in claim 1, wherein the electrolyte further comprises a nitrile-based compound, and
the nitrile-based compound is butyronitrile, valeronitrile, propionitrile, acetonitrile, or any combination thereof.

11. The lithium secondary battery as claimed in claim 1, wherein the negative current collector comprises copper, nickel, Nickel-coated copper, stainless steel, iron, cobalt, or an alloy thereof.

12. The lithium secondary battery as claimed in claim 1, wherein a concentration (ppm) of hydrogen fluoride (HF) after storing the lithium secondary battery comprising the electrolyte at a high temperature (60° C.) in a state of charge (100%) for 7 days is 20 ppm or less.

13. The lithium secondary battery as claimed in claim 1, further comprising a lithium metal layer between the negative current collector and the electrolyte.

14. The lithium secondary battery as claimed in claim 13, wherein the lithium metal layer comprises a lithium metal foil, lithium metal powder, a lithium alloy foil, lithium alloy powder, or any combination thereof.

15. The lithium secondary battery as claimed in claim 14, wherein the lithium alloy foil and the lithium alloy powder comprises lithium and a first metal, and
the first metal is indium, silicon, gallium, tin, aluminum, titanium, zirconium, niobium, germanium, antimony, bismuth, gold, platinum, palladium, magnesium, silver, zinc, iron, cobalt, chromium, cesium, sodium, potassium, calcium, yttrium, tantalum, hafnium, barium, vanadium, strontium, lanthanum, or one or more combinations thereof.

16. The lithium secondary battery as claimed in claim 1, further comprising a separator.

17. The lithium secondary battery as claimed in claim 16, wherein the separator comprises a porous substrate,
the porous substrate is a woven or non-woven fabric,
the porous substrate comprises an olefin resin, a fluorine resin, an ester resin, an imide resin, an acrylic resin, a cellulose resin, or any combination thereof,
the olefin resin comprises polyethylene, polypropylene, or a combination thereof,
the fluorine resin comprises polyvinylidene fluoride, polytetrafluoroethylene, or a combination thereof,
the ester resin comprises polyethyleneterephthalate, polybutyleneterephthalate, or a combination thereof,
the imide resin comprises polyamideimide, polyetherimide, or a combination thereof,
the acrylic resin comprises polyacrylonitrile, polyacrylate, or a combination thereof, and
the cellulose resin comprises carboxymethyl cellulose, microbial cellulose, plant cellulose, animal cellulose, or any combination thereof.

18. The lithium secondary battery as claimed in claim 1, further comprising a negative active material layer between the negative current collector and the electrolyte,
wherein the negative active material layer comprises: a carbonaceous material; a mixture of the carbonaceous material and at least one selected from among a metal and a metalloid; a composite of the carbonaceous material and at least one selected from among a metal and a metalloid; or any combination thereof.

19. The lithium secondary battery as claimed in claim 1, wherein the positive electrode comprises a positive current collector and a positive active material layer,
at least one of the positive current collector or the negative current collector comprises a base film and a metal layer on a side of the base film,
the base film comprises a polymer,
the polymer comprises polyethyleneterephthalate, polyethylene, polypropylene, polybutyleneterephthalate, polyimide, or any combination thereof, and
the metal layer comprises indium, copper, magnesium, stainless steel, titanium, iron, cobalt, nickel, zinc, aluminum, germanium, lithium, or any alloy thereof.

20. An electrolyte for a lithium secondary battery comprising an additive represented by Formula 1: 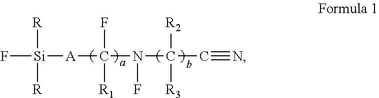
wherein, in Formula 1, A represents a chemical bond or —(CH₂)ₖ— (wherein k is an integer from 1 to 3),
a and b are each independently 0 or an integer from 1 to 3,
at least one of a or b is 0, and
R, R₁, R₂, and R₃ are each independently hydrogen, a C1-C10 alkyl group, or F.
